(19) United States
(12) Patent Application Publication
(10) Pub. No.: US 2026/0104112 A1
(43) Pub. Date: Apr. 16, 2026

(54) USE OF AN ELASTOMER SLEEVE FOR ASSEMBLY ON A LINE

(71) Applicant: HAUFF-TECHNIK GMBH & CO. KG, Hermaringen (DE)

(72) Inventors: Christian Hug, Heidenheim (DE); Senol Egritepe, Heidenheim (DE); Kristofer Schmidt, Nornheim (DE); Josef Gauss, Blaubeuren (DE); Jörg Schmid, Niederstotzingen (DE); Ralf Kurz, Giengen (DE)

(21) Appl. No.: 19/115,132

(22) PCT Filed: Sep. 25, 2023
(86) PCT No.: PCT/EP2023/076412

§ 371 Date: Mar. 25, 2025

(30) Foreign Application Priority Data
Sep. 26, 2022 (DE) 102022124662.0
Sep. 26, 2022 (DE) 102022124663.9
Sep. 26, 2022 (DE) 102022124664.7

(51) Int. Cl. F16L 5/10; H02G 3/22

(52) U.S. Cl. CPC F16L 5/10; H02G 3/22

(57) ABSTRACT

The invention relates to the use of an elastomer sleeve for mounting on a line, wherein first, the line is laid through the elastomer sleeve and in the process a supporting element is arranged in the elastomer sleeve and holds the elastomer sleeve in an expanded state; subsequently, the supporting element is removed from the elastomer sleeve and the elastomer sleeve comes into contact with the line; wherein in step i), in relation to a central axis of the elastomer sleeve, an area structure is arranged radially between the supporting element and the elastomer sleeve, and wherein the supporting element in step ii) slides out of the elastomer sleeve along the area structure.

The present invention relates to the use of an elastomer sleeve for mounting on a line, wherein the elastomer sleeve comes into contact with the line.

A method known in this respect relates to so-called heat shrinking, in which an elastomer sleeve is exposed to heat, for example with a flame or a hot air blower, after the line has been passed through. As a result of the heat, the elastomer sleeve contracts and comes into sealing contact with the line. This procedure can be dis-advantageous, for example, insofar as the exposure to heat can also impair the line, for example can damage the cable sheath or, depending on the type, also the cable core.

The present invention is based on the technical problem of specifying an advantageous use of an elastomer sleeve for mounting on a line.

This is achieved according to the invention with the use according to claim 1, wherein
i) first, the line is laid through the elastomer sleeve and in the process a supporting element is arranged in the elastomer sleeve and holds the elastomer sleeve in an expanded state;
ii) subsequently, the supporting element is removed from the elastomer sleeve and the elastomer sleeve contracts and comes into contact with the line;
wherein in step i), in relation to a central axis of the elastomer sleeve, an area structure is arranged radially between the supporting element and the elastomer sleeve, and wherein the supporting element in step ii) slides out of the elastomer sleeve along the area structure.

Along the area structure, which can be, for example, a fabric/nonwoven fabric layer or in particular a film or plastic film, the supporting element can slide out of the elastomer sleeve well, better than if it were to bear directly against the inner wall surface of the elastomer sleeve. This is because the latter would result in a higher coefficient of friction on account of the elastomer material of the elastomer sleeve; the removal/sliding out of the supporting element would be at least made more difficult. After the removal of the supporting element, the elastomer sleeve previously held in a radially expanded state by the supporting element contracts. It thus comes into contact with the outer wall surface of the line, wherein, for example, a relatively large-area and thus as a result well-sealing contact surface can be achieved. In comparison with the example mentioned above, this procedure can also be gentle on the material, that is to say the risk of damage can be reduced.

Preferred embodiments can be found in the entire disclosure and in particular in the dependent claims, wherein, in the description of the features, a distinction is not always made in detail between use aspects or method aspects and apparatus aspects; in any case, the disclosure is directed implicitly to all claim categories.

In the step according to item i), the supporting element holds the elastomer sleeve in an expanded state, that is to say the inside diameter of the elastomer sleeve is greater than in a state free of external forces (that is to say than in a comparative case without supporting element and line). After the removal of the supporting element, the diameter of the elastomer sleeve decreases overall (that is to say the mean value of inside diameter and outside diameter), and on account of the de-creasing inside diameter it comes into contact with the outer wall surface of the line. In other words, in a state free of external forces, the elastomer sleeve has an inside diameter which is smaller than the outside diameter of the line passed through, for example by at least 5%, 10%, or 15% (with possible upper limits at, for example, at most 70%, or 50%).

Generally, within this disclosure, “diameter” in general relates to the mean value of smallest and greatest extent perpendicular to a central axis of the elastomer sleeve, which corresponds to the circle diameter in the preferred case of an elastomer sleeve which is circular in cross section. The specifications “axial”, “radial” and “circumferential”, and the associated directions (axial direction etc.) also relate to said central axis. This also applies, without the opposite specification, to “inside” and “outside”, that is to say an inner wall surface faces toward the central axis and an outer wall surface faces away from it.

The “line” can be, for example, a pipe which is used either for conducting a fluid, for example water or gas, or can itself serve as a protective pipe for laying the actual line; on the other hand, however, the line can also be, for example, a cable, for instance an electrical or data cable. In other words, the line can be a gas, water, district heating, electrical or data line, wherein applications in station construction can be particularly preferred, that is to say, for example, so-called medium-voltage cables.

The “elastomer material” of the elastomer sleeve is quite generally a plastic with elastic behavior. The Shore hardness (Shore A) thereof can be, for example, at most 90 Shore, 80 Shore, 75 Shore, or 70 Shore and (independently thereof), for example, at least 20 Shore, 25 Shore, 30 Shore, 35 Shore, or 40 Shore. It can be, for example, a rubber material, preferably a synthetic rubber, for instance EPDM (ethylene-propylene-diene, M group). Likewise, however, it can also be, for example, a thermoplastic elastomer (TPE) or a silicone-based material, for instance silicone rubber or silicone elastomer.

In general, the supporting element can have any desired shape as long as it holds the elastomer sleeve in an expanded state, on the one hand, and allows a line to be led through, on the other hand. This could also be achieved, for example, with a supporting element which is cross-shaped (and not necessarily symmetrical in this case) as viewed axially, wherein the line can then be pushed through a quadrant thereof (which can be relatively larger on account of the asymmetry). Furthermore, a supporting element which is V-shaped as viewed axially would also be conceivable, for example. An idea remains, irrespective of the shape of the supporting element, that the area structure simplifies the sliding out.

In a preferred embodiment, however, the supporting element is a supporting sleeve, that is to say it encloses a passage opening through which the line is laid. Generally, specifications relating to the supporting sleeve or the supporting element generally refer, without an explicitly opposite specification, to the state arranged in the elastomer sleeve, that is to say the step according to item i). A passage opening which is defined centrally and preferably coaxially with the elastomer sleeve by the supporting sleeve can simplify, for example, the threading-through of the line. The supporting sleeve encloses the passage opening at least over a larger part of the circumference, for example over at least 75%, 85%, or 90%; in general, for example, a tube which is slotted longitudinally (axially) on a radial side can also form the supporting sleeve. Preferably, however, the supporting sleeve completely encloses the passage opening in the circumferential direction. In general, it can also be provided in a plurality of parts in relation to the circumference, for example be composed of two half shells (which together completely enclose the passage opening). Preferably, however, the supporting sleeve is closed circumferentially in itself, that is to say in one piece.

In a particularly simple and solid embodiment, the supporting sleeve can be a tube piece, for example composed of a hard plastic, cf. the Shore hardness (D) values specified below for the snap ring of the variant “casing tube” (but alternatively also made of metal, for example). In general, however, the supporting sleeve can also have, for example, a grid-shaped wall, that is to say the supporting sleeve wall does not necessarily have to be of closed design. Preferably, as far as the sliding out is concerned, an outer wall surface which is smooth when viewed in an axial section, that is to say overall in particular in the form of a cylindrical lateral surface, is nevertheless preferred. Alternatively, or preferably in combination therewith, as far as the passage of the line is concerned, an inner wall surface which is smooth when viewed in the axial section and in particular in the form of a cylindrical lateral surface is preferred.

In general, the supporting sleeve can also have a spiral-shaped construction, wherein axially adjacent spiral sections can be connected to one another, for example via predetermined breaking points. For the purpose of being removed, this spiral-shaped supporting sleeve can then be gripped and pulled at one end, as a result of which the predetermined breaking points are successively separated off and the consequently “elongated” spiral shape slides out of the elastomer sleeve along the area structure. However, such a supporting sleeve can be complicated to produce, for which reason the supporting element generally and in particular the supporting sleeve preferably slides out of the elastomer sleeve as a whole, for example without an accompanying change in shape such as in the example of the spiral.

As mentioned above, a basic function of the area structure lies in the reduced friction—a coefficient of friction which relates to the static or sliding friction is therefore smaller for the supporting element in relation to the area structure than for the supporting element in relation to the elastomer sleeve. The supporting element can be removed in different ways, for example by correspondingly compressing the elastomer sleeve next to the supporting element, which takes place successively with sub-sequent gripping, the supporting element can be squeezed out of the elastomer sleeve axially. Alternatively, the supporting element can also protrude axially from the elastomer sleeve and can then be gripped and pulled out easily. Furthermore, a thread and/or a cord can also be provided on the supporting element, for example, as a result of which pulling out is also possible if the supporting element itself does not protrude axially from the elastomer sleeve. Irrespective of the manner in which force is applied in detail, the area structure facilitates the axial sliding out or sliding out of the supporting element in all these cases.

According to a preferred embodiment, the area structure itself is used to apply the pull-out force. This is described below on the basis of a “first axial direction” along which the supporting sleeve slides axially out of the elastomer sleeve and which, by definition, points from a first to a second axial end of the supporting sleeve. If the supporting sleeve in step i) is, for example, arranged completely axially within the elastomer sleeve, first the second end and then the first axial end of the supporting sleeve protrudes out of the elastomer sleeve during the removal.

With the area structure, the force is transmitted to the first axial end of the supporting sleeve during or for the purpose of removing the latter. For this purpose, that section of the area structure which has already become free at a respective point in time, that is to say is no longer held radially between the supporting sleeve and the elastomer sleeve on account of the already partial sliding out, is pulled out through the supporting sleeve in the first axial direction. At points in time during the pulling out, therefore, in each case a section which still remains is arranged between the supporting sleeve and the elastomer sleeve, and the section which has already become free extends away therefrom around the end side of the supporting sleeve at the first axial end into the passage opening of the latter, and the force is applied thereto by pulling. Fspitzor the purpose of pulling, it is generally also possible, for example, to grip into the passage opening with long-nose pliers, preferably the section which has already become free protrudes at the second axial end, that is to say can be pulled easily by hand, for example.

Basically, the supporting sleeve in this case could initially also be squeezed out in a manner described above, and the section of the area structure which has become free could then be gripped in or through the passage opening with, for example, pliers and used for the final pulling out. In a preferred embodiment, however, already in step i) an end section of the area structure is folded inwards into the supporting sleeve, that is to say it extends at least into the passage opening (generally not necessarily out at the second axial end). Preferably, however, the folded-in end section is so long that it also already protrudes from the second axial end in step i). After the line has been guided through, it can then be gripped particularly easily, for example by hand, and pulled in the first axial direction, that is to say axially away from the elastomer sleeve, for the purpose of pulling out the supporting element.

In step i), the end section of the area structure which is folded in at the first end of the supporting sleeve can in this case protrude axially at the second end of the supporting sleeve, on the one hand, that is to say can still extend a distance away from the second end in the first axial direction. Alternatively, however, that part of the end section which is folded in at the first end of the supporting sleeve which protrudes at the second end can also be folded outwards at the second end, that is to say can be seated on the outer wall surface of the elastomer sleeve. This can have, for example, a certain protective function and/or simplify the threading-through of the line.

In general, the supporting sleeve can be slotted in a preferred embodiment, that is to say can be provided with an axially continuous slot. On account of this slot, the sleeve can be folded open, that is to say can then be lifted radially from the line, for example after being removed from the elastomer sleeve. For this purpose, the slot can already be provided completely continuously in the initial state or can also be provided only with a predetermined breaking point, for instance a region of reduced wall thickness and/or a perforation.

As mentioned above, the subject matter of the invention can be realized in principle with any area structure which reduces the static friction for the supporting element. Therefore, for example, a woven or knitted fabric, and in particular also a nonwoven fabric, can also be considered, wherein such a fabric can also be coated, for instance waxed or the like, in order to (further) reduce the friction. In a preferred embodiment, the area structure is nevertheless provided as a plastic film, which can have advantages, for example, in terms of costs. The plastic film can have, for example, a thickness of at most 1 mm, with further upper limits at, for example, at most 0.8 mm or 0.6 mm (and independent lower limits at, for example, at least 10 μm or 20 μm). PVC, PP and PE, for example, come into consideration as preferred materials for the plastic film.

In a preferred embodiment, the area structure, in particular the plastic film, is closed circumferentially in itself, that is to say it has a tubular shape. This can simplify, for example, the assembly of supporting element, area structure and elastomer sleeve, namely prevent slippage and thus incorrect placements.

The invention also relates to an elastomer sleeve arrangement with elastomer sleeve, supporting element/supporting sleeve and area structure/plastic film in between, with respect to possible details, reference is explicitly made to the above description.

Furthermore, the invention relates to a method for producing such an elastomer sleeve arrangement, wherein the supporting sleeve is axially slotted and consequently radially compressed or compressible. In a radially compressed configuration, two end sections of the supporting sleeve, which bear against one another in the radially expanded configuration at the slot, overlap. Due to the overlap in the circumferential direction, that is to say because the end sections are arranged radially one after the other in the compressed configuration, the circumference is reduced, with the result that the supporting sleeve can be easily inserted into the elastomer sleeve. In this case, the area structure can already be introduced into the elastomer sleeve beforehand or can be pushed in together with the supporting sleeve (as during the removal, the relatively lower friction on the area structure can also be used during the pushing-in process).

In the compressed configuration, the outside diameter of the supporting sleeve can correspond substantially to the inside diameter of the elastomer sleeve, or can also be smaller or even somewhat greater (a certain expansion during the pushing-in process is possible). In the elastomer sleeve, the supporting sleeve is then expanded, for example by an expansion tool being inserted and the supporting sleeve being expanded, for example until the end sections no longer overlap but come to bear against one another with their abutting edges. The expansion tool can be realized, for example, with pins (see below) or with cones which are applied axially on both sides and are moved toward one another. The end sections are subsequently supported mutually in the circumferential direction, which stabilizes the entire supporting sleeve and thus also the expanded elastomer sleeve in this configuration.

In order to further stabilize this expanded configuration, the abutting edges can be profiled. This profiling can lead, for example, to the one end section pressing the other end section, which was radially inside in the compressed configuration, radially outward (with an oblique flank) in the expanded configuration. Alternatively or additionally, the end sections can also engage in one another in a form-fitting manner, that is to say a form fit created with the profiling can prevent a radial offset, for example a tongue/groove profile or a zigzag shape or the like.

Alternatively to the production described above by expanding an axially slotted supporting sleeve, the elastomer sleeve arrangement can also be produced with an expansion tool which is inserted into the elastomer sleeve and expands the latter. The supporting element with the area structure, in particular the supporting sleeve with the plastic film, is then pushed into the elastomer sleeve expanded by the expansion tool, and the expansion tool is then pulled out axially. In this case, the expansion tool can have a plurality of pins which each extend axially and are pushed into the elastomer sleeve and moved apart from one another for expansion (at least 3, preferably at least 4 or 5 such pins). Since each pin per se has only a relatively small contact surface on the elastomer sleeve, the expansion tool can then be pulled out axially well even in the expanded state of the elastomer sleeve.

As described above, a seal with respect to a line can be realized relatively easily and quickly with the present subject matter. The line is preferably sealed by means of the elastomer sleeve with respect to an opening, in particular through-opening, in a wall or floor element. The wall or floor element can be provided in particular from stone or concrete and/or be part of a building structure, that is to say a wall or floor element of a building. In a typical application, the line is laid through a through-opening in the wall or floor element, the elastomer sleeve preferably already being fixed in position relative to the wall or floor element, in particular being sealed with respect thereto.

In a particularly simple case, for this purpose, for example a flange portion composed of the same elastomer material can be provided axially adjacent to the elastomer sleeve, which flange portion is sealed with respect to a side surface of the wall or floor element, for example with a ring which is screwed with respect to the wall or floor element and is composed of metal or plastic. The elastomer sleeve can also be placed, for example, onto a pipe end, that is to say can seal the pipe with respect to a line which is laid therein and protrudes from the pipe end. Such a pipe can be, for example, a protective pipe which is laid in the ground and/or also a so-called monoblock pipe, in which a plurality of lines are combined for a district heating or in particular heat pump application. Alternatively, however, the pipe can also be mounted, for example as a casing pipe, in a wall or floor element, for example mechanically fastened and/or cast in, and in this case the elastomer sleeve can be placed on an end section of the pipe which protrudes from the wall or floor element. Irrespective of the type or application of the pipe in detail, the elastomer sleeve can be pressed radially inward toward an outer wall surface of the pipe for an additional fastening, for example with a clamping ring, for example a tension clamp.

The elastomer sleeve can also be cast into the wall or floor element, for example on its own or together with a casing pipe. In the first-mentioned case, the elastomer sleeve can have, for example, a circumferential bead on an outer circumferential surface and can be supported radially inward by a supporting element during casting, which supporting element can then be removed together with the formwork after the setting in concrete (such that only the elastomer sleeve is still seated in the opening). However, the elastomer sleeve can also be cast or set in concrete together with a casing pipe, the casing pipe supporting the elastomer sleeve radially inward during casting and then also remaining in the wall or floor element after the removal of the formwork.

Alternatively, the elastomer sleeve can also be pressed radially outward with a clamping ring, for example against the inner wall surface of a pipe and/or against the soffit of an opening in a wall or floor element. This opening can either be formed by a pipe (casing pipe) or also be provided directly in the wall or floor element, for example be introduced as a so-called core bore. With respect to a possible embodiment of a corresponding clamping ring for pressing radially outward, reference is made to EP 3 502 534 A1.

However, the elastomer sleeve can also be fastened or integrated on a so-called press seal, the press seal having an elastomer body and a clamping device. With the latter, the elastomer body can be axially compressed and consequently pressed radially against a soffit delimiting the through-opening, as a result of which the seal with respect to the wall or floor element is created. In this case, a passage opening which is large in relation to the line can be provided in the elastomer body, the seal with respect to the line is then produced by means of the elastomer sleeve. Furthermore, the elastomer sleeve can also be part of a system insert, for example, which is mounted in a casing pipe which is installed in the wall or floor element, in particular cast therein, for example with a screw or latching mechanism.

An advantageous embodiment which is preferably provided in combination with the supporting sleeve, but can generally also be of interest independently thereof, relates to the use of an insert for mounting in a casing tube in a wall or floor element made of concrete or stone. This is also referred to below as a variant “casing tube”.

The casing tube, which can be part of a so-called line duct, for example, is usually set in concrete in the wall or floor element in the course of the production of the latter. For this purpose, it is placed in a corresponding formwork which is then filled with concrete, wherein the casing tube keeps the through-opening free. After the removal of the formwork, it remains in the solidified concrete. In f known designs, a plurality of projections are provided in a circumferentially distributed manner on the inner wall of the casing tube, which projections interact with system covers which can be inserted into the pipe element in the manner of a screw or bayonet closure. Depressions which take account of the projections are therefore formed on an associated system cover, with the result that it can be screwed or locked into the casing tube by rotation. The line can be laid through the system cover and sealed with respect thereto.

The variant “casing tube” is based on the technical problem of specifying an advantageous use.

This is achieved with the use according to the following first aspect, specifically the fastening of the insert in the through-opening with the aid of a snap ring. For this purpose, said snap ring is pushed into the casing tube in a pushing-in direction until it engages behind a flank which is formed on the inner wall surface of the casing tube and is therefore latched in the casing tube. In this case, the insert is also held in position with or by the latched snap ring.

Even if the flank which is engaged behind in a form-fitting manner by the snap ring is formed by a threaded section, which is preferred, the latching can offer advantages over the screwing-in of a system cover. Specifically, the snap ring can be less susceptible, for example, with respect to twisting, with the result that a rotational movement which is applied, for example, via a torsion of the line leads less easily to an unintentional release. On the other hand, the possibility of the simple pushing into the snap seat, without a specifically required rotational movement etc., can also simplify the assembly. This can be advantageous specifically under restricted spatial conditions, for example if the insert has to be handled in a trench in the ground which is difficult to access.

Preferred embodiments can be found in the entire disclosure and in particular the dependent claims, wherein, in the description of the features, a distinction is not always made in detail between the different claim categories; in any case, the disclosure is always to be read implicitly both with respect to use aspects or method aspects and with respect to corresponding apparatus features.

The snap ring “engages behind” the flank on the inner wall surface of the casing tube, that is to say is held in an axially form-fitting manner on the flank in relation to an axial direction which is opposite to the pushing-in direction, in which the snap ring is pushed into the snap seat. When viewed in an axial section, in which the sectional plane contains a longitudinal axis of the through-opening, the flank of the casing tube points in the direction of the pushing-in direction. A contact surface of the snap ring, which then bears against it in a form-fitting seat, points in the opposite axial direction (“pull-out direction”) and is thus held in an axially form-fitting manner. Generally, within the scope of the variant “casing tube”, the specifications “axial”, “radial” and “circumferential” relate to the respective relevant axis, that is to say in the example of the same to the longitudinal axis of the through-opening (in other cases to a central axis of an elastomer sleeve of the insert, see below in detail). Without the opposite specification, “inside” and “outside” relate to the radial directions, that is to say, for example, an inner wall surface faces toward the respective axis and an outer wall surface faces away radially from the axis (by contrast, if the arrangement or a feature relates to the axial direction, for example in the case of an “end face”, this is specified correspondingly). During the assembly in the casing tube, the snap ring is pushed into the snap seat with an at least partially axial movement (this can also be combined, for example, with a slight rotation), preferably the axial component has the greatest proportion of the movement, particularly preferably the movement takes place exclusively axially.

The line is laid through the insert, which can take place before or preferably after the fastening thereof in the through-opening. Irrespective of the sequence in detail, the insert is then sealed with respect to the line, preferably by means of an elastomer sleeve shrunk onto the line (see below in detail). In general, however, the insert could also be sealed with respect to the line with a pinch seal or the like.

Furthermore, the snap ring and the insert can generally also be provided in one piece or even monolithically with one another, wherein, within the scope of this disclosure, “in one piece” means not separable in a non-destructive manner and “monolithically” means continuously formed from the same material without interruption, that is to say without a material boundary therebetween. The snap ring and the insert can therefore generally also be provided, for example, as a cohesive single-component or multi-component injection-molded part; for example, the insert can be injection-molded as a soft component, for instance from TPE, onto the snap ring as a hard component, for instance from ABS.

In general, for instance in the case of the embodiment as a multi-component injection-molded part, the insert can also adjoin the snap ring axially, that is to say can sometimes also sit outside the through-opening in the mounted state, wherein the snap ring is then for example sealed separately with respect to the casing tube (for example with a sealing ring). In a preferred embodiment, however, at least one fastening portion of the insert is provided from an elastomer material, wherein the snap ring presses this fastening portion against the inner wall surface of the casing tube in its latching position. In this case, although the fastening portion and therefore the insert and the snap ring can generally still be provided in one piece with one another (for example the insert/fastening portion can be injection-molded onto the snap ring as a soft component), this preferably relates, however, to an insert which is multi-piece with respect to the snap ring and which is further preferably provided per se monolithically from an elastomer material. With the pressing outward, the elastomer fastening portion and therefore the insert can firstly be fastened in the casing tube and at the same time sealed with respect thereto.

The “elastomer material” is quite generally a plastic with elastic behavior. The Shore hardness (Shore A) thereof can be, for example, at most 90 Shore, 80 Shore, 75 Shore, or 70 Shore and (independently thereof), for example, at least 20 Shore, 25 Shore, 30 Shore, 35 Shore, or 40 Shore. It can be, for example, a rubber material, preferably a synthetic rubber, for instance EPDM (ethylene-propylene-diene, M group). Likewise, however, it can also be, for example, a thermoplastic elastomer (TPE) or a silicone-based material, for instance silicone rubber or silicone elastomer.

In a preferred embodiment, the snap ring and the insert are composed in a plurality of parts in relation to one another, that is to say as previously separately produced parts. In this case, they can generally nevertheless be connected to one another in one piece, that is to say cohesively, for instance adhesively bonded. They are preferably in a plurality of parts in relation to one another, that is to say they can be disassembled in a non-destructive manner (before the mounting in the casing tube). In general, the two could also be mounted sequentially in the through-opening, that is to say for example firstly the insert could be placed from one side and then subsequently the snap ring could be placed from the other side into the through-opening.

Preferably, however, the snap ring and the insert are pushed into the casing tube together, that is to say in the composed/assembled state. During the pushing into the casing tube, therefore, at least one portion of the snap ring, which then presses the elastomer fastening portion outward, is already positioned radially inside the fastening portion. The joint insertion can simplify the handling, for example, and the two can be pushed in from one side (in the pushing-in direction), preferably from the outside.

According to a preferred embodiment, the insert, specifically the elastomer fastening portion, is pulled onto the snap ring, that is to say the elastomer fastening portion is at least temporarily expanded during the assembly with the snap ring. In the composed/assembled state, it is seated axially in a form-fitting manner on the snap ring, wherein it is preferably still expanded in relation to a state free of external forces, that is to say has some undersize in other words. Due to the form-fitting seat and preferably additionally a force-fitting seat caused by undersize, the elastomer fastening portion is held well on the snap ring. This can be advantageous specifically under difficult assembly conditions (for example poor accessibility or visibility), because the fitter then at least has to pay less attention to the correct seat of insert and snap ring during the pushing into the through-opening. The form fit exists at least with respect to an axial direction which is opposite to the pushing-in direction (“pull-out direction”), preferably it also exists additionally in the pushing-in direction.

According to a preferred embodiment, the elastomer fastening portion has an engagement portion which engages behind a flank which is formed on the outer wall surface of the snap ring, is preferably seated axially on both sides in a manner enclosed in a groove which is formed in the outer wall surface of the snap ring. When viewed in an axial section, the flank of the snap ring points in the pushing-in direction, and due to its bearing against it, the engagement portion of the fastening portion is held in the pull-out direction. After the pushing into the casing tube, the inner wall surface thereof holds the engagement portion radially in position (for example in the groove), that is to say prevents the engagement or fastening portion overall from expanding and thus sliding out.

In a preferred embodiment, an outer wall surface of the engagement portion is made so as to rise outwards in the pull-out direction. The outer wall surface therefore has a diameter which increases in the pull-out direction, in other words the outside diameter of the engagement portion increases in the pull-out direction. If the engagement portion is preferably seated in a groove, it preferably has an outside diameter corresponding to that of the snap ring at its front end in the pushing-in direction, which is first introduced into the through-opening during the pushing in. The outside diameter of the engagement portion then increases slightly opposite to the pushing-in direction, which leads to an increasing pressing-on and pressing-in during the pushing into the through-opening.

According to a preferred embodiment, the elastomer fastening portion has a sealing portion following the engagement portion in the pull-out direction. Although the engagement portion is preferably also already pressed against the inner wall surface (irrespective of whether with or also without rising outer wall surface), the pressing-on force can be even higher in the sealing portion. The sealing portion preferably forms a radially outwardly protruding elevation on its outer wall surface, which elevation is preferably closed circumferentially in itself and can generally be provided, for example, in the form of a bead. The elevation is preferably provided as a sealing lip which particularly preferably rises obliquely outwards when viewed in an axial section, to be precise inclined in the pull-out direction. The elevation can therefore slide easily into the casing tube, on the one hand; on the other hand, water which is present cannot easily flush over the elevation in the pushing-in direction, but would press the elevation even more strongly against the inner wall surface of the casing tube at least to a certain extent on account of the oblique shape.

The outer wall surface of the snap ring is preferably formed with a radial elevation in the region of the sealing portion, in particular upstream of the elevation thereof in relation to the pushing-in direction, which radial elevation therefore slides into the through-opening after the elevation of the sealing portion during the insertion. This elevation on the snap ring can press the sealing portion, in particular the elevation which is formed there, easily against the inner wall surface of the casing tube. A radial depression is preferably formed in the snap ring upstream of the elevation in the sealing portion of the insert in the pushing-in direction, generally also independently of the just-discussed elevation of the snap ring, but preferably in combination therewith and then also before the elevation (of the snap ring) in the pushing-in direction (it therefore slides into the through-opening after the elevation during the insertion). The depression can provide some space into which the elastomer fastening portion can be deformed, that is to say can yield. Although the elevation of the sealing portion is then pressed sufficiently against the casing tube, excessive squeezing can be prevented somewhat, on the other hand.

In a preferred embodiment, a threaded section which is provided on the inner wall surface of the casing tube forms the flank which is engaged behind by the snap ring, cf. also the remarks at the outset (in contrast, in general, any desired projection on or a depression in the inner wall surface could also form the flank). The threaded section is preferably formed monolithically with the rest of the casing tube and/or extends circumferentially only over one segment, that is to say not completely circumferentially. There can then be a plurality of threaded sections which are distributed over the circumference and each extend over a segment. These threaded sections are preferably arranged at the same axial position and can preferably each extend over the same angle, in particular be at least partially rotationally symmetrical in relation to one another about the through-opening longitudinal axis.

Even if the casing tube is therefore designed with the threaded section for the insertion of a system cover, this option is not used in the present case, but rather the insert is fastened with the snap ring instead. This can expand the application possibilities, for example, the present subject matter can be used, for example, in an assembly environment which is difficult to access or is difficult to see, whereas a system cover can be screwed into a structurally identical casing tube under “normal” conditions. This creates flexibility, specifically the casing tube which is installed in the wall or floor element could only be removed/replaced with considerable effort, but the optional equipping with system cover or insert with snap ring nevertheless allows a later adaptation.

In a preferred embodiment, before the insert with the snap ring is inserted into the casing tube, in particular during the installation of the casing tube in the wall or floor element, a closure cover is held in the casing tube via the threaded section. Said closure cover can, for example when the casing tube is cast into a wall or floor element made of concrete, sit axially at the end side in the casing tube and thus prevent penetration of concrete or also generally soiling. The closure cover is subsequently released by rotation and removed from the through-opening.

According to a preferred embodiment, the snap seat between snap ring and casing tube exists independently of the rotational position, that is to say the snap ring is held in a form-fitting manner in the casing tube in any desired rotational position (over 360°). During a rotation of the snap ring, its axial position preferably also remains unchanged, even if the flank is formed on a threaded section. For this purpose, the snap ring can bear in a form-fitting manner against a rear end of the threaded section in the pushing-in direction, with the result that it does not slide along the threaded section during the rotation. As already mentioned at the outset, the snap seat which is independent of the rotational position can prevent an unintentional release, and in addition the assembly can also be simplified as a result.

In general, a snap section of the clamping ring which latches with the casing tube can be subdivided circumferentially continuously without interruption or by separating joints into snap tongues. The separating joints can simplify, for example, a certain radial deflection of the snap tongues when the snap ring is pushed into the snap seat, that is to say reduce, for example, the force expenditure during the pushing-in of the snap ring. Conversely, however, they are not mandatory, the snap section and in particular a flank thereof which then bears in an axially form-fitting manner and points in the pull-out direction can also be closed circumferentially in itself. Even if the snap ring is provided from a comparatively hard material, the elasticity thereof can still permit a sufficient deflection of said flank of the snap ring radially inward during the pushing into the snap seat.

If the flank of the snap ring and/or the flank of the casing tube runs without interruption in the circumferential direction, there is a snap seat which is independent of the rotational position in any case. However, this can also be achieved if both flanks are each interrupted in the circumferential direction as long as a bearing always exists despite the interruptions (that is to say the interruptions are bridged to a certain extent).

In general, the snap ring can also be provided from metal, but in a preferred embodiment it is a hard plastic part. The hard plastic can have, for example, a Shore hardness (D) of at least 70 Shore, with possible (independent) upper limits at, for example, at most 95, or 90 Shore. Possible hard plastics are, for example, PS, PC, ABS, PP and PA66; the snap ring can be produced in particular by injection molding (that is to say can also be an “injection-molded part” independently of the specific plastic).

According to a preferred embodiment, the snap ring has a pre-latching portion which is arranged in front of the flank in relation to the pushing-in direction, that is to say comes into engagement with the projection or threaded section before the flank when the snap ring is pushed in. This pre-snap can create a certain pre-fixing and thus simplify, for example, the further assembly. A plurality of pre-snap sections can be provided in a circumferentially distributed manner, wherein the pre-latching portion or pre-latching portions, added up over a circumference, preferably has or have a smaller length than the flank (wherein the length of the flank, added up over a circumference, is also considered).

This is particularly preferably to the effect that, although on the one hand the flank, that is to say the snap ring in the latched state, is held in the casing tube independently of the rotational position, the pre-snap can be released by rotation. In other words, the pre-snap can be produced only on one or a few specific rotational positions, whereas the pre-latching portions, on a different rotational position, slide past the projections or threaded sections in the casing tube when pushed in (that is to say only then engage the flank when pushed in). In yet other words, the snap ring can be pre-latched on one rotational position, but this pre-snap can be released again on a different rotational position.

The casing tube can be equipped, specifically with regard to the function just described, but generally also independently thereof, with a plurality of projections, in particular threaded sections, which are provided in a circumferentially distributed manner. In this case, the projections are preferably provided and arranged in such a way that, as viewed in the axial direction, there is in each case a spacing between two projections which are nearest neighbors in the circumferential direction. In other words, a perpendicular projection of the projections into a plane which is perpendicular to the axial direction does not form a closed line, but rather the ring shape is in each case interrupted between two sections. A snap ring just described can pre-latch when the pre-latching portions are axially aligned with the projections, but if they are arranged in the interruptions between them, the snap ring can therefore be removed.

According to a preferred embodiment, the snap ring is equipped with a predetermined breaking point, wherein a part of the snap ring can be opened up or separated off by separating off the predetermined breaking point. With the splitting up or separating off of the part, the structural integrity of the snap ring is reduced or completely broken open in such a way that the snap seat is released. This permits disassembly of the snap ring and therefore of the insert, and can therefore open up inspection possibilities, for example, or permit another line occupation. In general, for example, a perforation or the like can also create the predetermined breaking point. However, this is preferably a region of reduced wall thickness, which can also be implemented easily, for example, in an injection molding tool. Irrespective of the specific embodiment of the predetermined breaking point, it is also intended to be explicitly disclosed that, in the application for disassembly, said predetermined breaking point is separated off and the snap ring is removed from the through-opening, preferably also the insert.

The predetermined breaking point can extend circumferentially, for example, and can therefore be arranged axially between the mounting section of the snap ring, which presses against the fastening portion, and that flank of the snap ring which forms the snap seat; after the axial separation, the snap ring parts can then be removed from the through-opening, for example, on different sides. In a preferred embodiment, however, the predetermined breaking point extends at least partially axially along the snap ring. This can generally also be combined with a partial extent in the circumferential direction (that is to say spiral-shaped to a certain extent), but an exclusively axial orientation is nevertheless preferred.

Irrespective of whether only partially or exclusively axially, the predetermined breaking point does not necessarily have to extend axially over the entire snap ring; it can also end, for example, within the axial extent thereof. Although the snap ring is then not completely interrupted with the separation, it is reduced in terms of its structural integrity, as described above. A predetermined breaking point which extends axially over the entire snap ring is nevertheless preferred. A plurality of predetermined breaking points which each extend at least partially axially and particularly preferably each extend axially over the entire snap ring are preferably provided in a circumferentially distributed manner.

In general, the snap ring is preferably a one-piece, preferably monolithic part. It can be provided, for example, as an injection-molded part, in particular a single-component injection-molded part. Despite the preferred one-piece nature, it can generally also be provided in a plurality of parts or in a plurality of pieces, namely a first axial section, composed with a second axial section, can form the snap ring. The first axial section can then press the fastening portion of the insert against the inner wall surface of the casing tube, for example, whereas the second axial section forms the snap seat with the casing tube. In this case, these axial sections can for their part be latched to one another, that is to say, for example, the second axial section can be pushed into the first axial section and held therein in an axially form-fitting manner. In the case of such a multi-piece embodiment, a predetermined breaking point mentioned above can then also be provided, for example, only in one of the axial sections, in particular in the second axial section.

As mentioned above, the fastening portion is preferably provided from an elastomer material, particularly preferably the insert overall is an elastomer part. According to a preferred embodiment, in order to disassemble the snap ring, the elastomer material is separated off, for example cut open with a knife, and the snap ring is then broken out. The latter can be simplified in particular by the predetermined breaking point(s) discussed above. The separation of the insert can advantageously permit disassembly “from the outside”; it does not have to be handled inside the transformer/compact station, for example (see below in detail). Irrespective of this, the snap ring can also be seated closer to the outside, for example, that is to say can then be more easily accessible.

According to a preferred embodiment, the snap ring latches audibly during the mounting of the insert, that is to say the reaching of the snap seat can be perceived by the fitter by a click noise. This can serve in a relatively simple manner for a mounting control, which can be advantageous in particular in the case of poor accessibility and visibility.

The insert preferably has an elastomer sleeve through which the line is laid; by sealing the elastomer sleeve with respect to the line, said line is then sealed with respect to the insert and therefore preferably with respect to the wall or floor element. In general, for this purpose a tension clamp can also be arranged on the elastomer sleeve, for example, with which tension clamp the elastomer sleeve is then pressed against the line passed through. However, the elastomer sleeve is preferably shrunk onto the line, particularly preferably by a supporting element being removed from the elastomer sleeve and holding the latter in a previously expanded state. In a state free of external forces, the elastomer sleeve therefore has a radial undersize in relation to the supporting element, for which reason it is seated in an expanded state on the supporting element. Said supporting element holds the elastomer sleeve in an expanded state for the line to be led through, and is subsequently removed from the elastomer sleeve. For this purpose, the supporting element can generally also have a spiral shape, for example, and can be gripped at one end and pulled out of the elastomer sleeve. In a preferred embodiment, however, the supporting element is provided in the form of a supporting sleeve, wherein an area structure is particularly preferably arranged radially between the supporting sleeve and the elastomer sleeve.

The “passive” sealing of the elastomer sleeve by shrinking on can be of particular advantage in conjunction with an elastomer joint (see below), because the elastomer joint can reduce an interaction between the elastomer sleeve and the insert. Therefore, the elastomer sleeve shrunk onto the line and therefore seated in a relatively “taut” manner on the line cannot lead to an undesired/excessive introduction of force into the fastening of the insert in the through-opening, on the one hand. On the other hand, an introduction of force into the elastomer sleeve itself can also be reduced, for example, with the tilting, that is to say a reliable seal can also be achieved, for example, without a tension clamp arranged on the elastomer sleeve. The advantages of the insert under spatially restricted/difficult-to-access conditions have already been discussed, wherein the elastomer sleeve which comes into contact automatically can constitute a further module. Under the restricted conditions, for example, no tensioning mechanism of a clamp then has to be actuated by rotation of a screw or the like, instead, after the line has been led through, the supporting element can simply be removed from the elastomer sleeve and the latter can therefore be sealed with respect to the line comparatively easily.

According to a preferred embodiment, if the supporting element is arranged in the elastomer sleeve and holds the latter in an expanded state, an area structure is arranged radially between the supporting element and the elastomer sleeve. If the supporting element is then removed from the elastomer sleeve, it slides along the area structure, which can simplify the removal. The supporting element can slide well on the area structure, which can be, for example, a fabric/nonwoven fabric layer or in particular a film or plastic film, because it has a lower friction (static and/or sliding friction) in relation to the area structure than it would have in comparison with the elastomer sleeve.

The supporting element is preferably a supporting sleeve, and the area structure itself is particularly preferably used to pull out the supporting sleeve. For this purpose, a section of the area structure which adjoins the section arranged radially between the supporting sleeve and the expanded elastomer sleeve can be folded inwards into the supporting sleeve around a first axial end of the latter. The section can in particular be so long that it protrudes or can at least be gripped at the opposite second axial end. For the purpose of removing the supporting sleeve, this section is then pulled in a pull-out direction which points from the first to the second axial end. This pull-out force is transmitted to the supporting sleeve at the first axial end via the wrap, with the result that it slides out of the elastomer sleeve in the pull-out direction (along the respective section of the area structure which still remains between the supporting sleeve and the elastomer sleeve).

Irrespective of these details, the elastomer sleeve is also preferably provided on the rest of the insert in a tiltable manner via an elastomer joint, which can open up flexibility in the line laying. The combination of the elastomer sleeve, which can be tilted by means of the elastomer joint and serves for the seal with respect to the line, on the one hand, and the fastening by means of a latching/snap ring, on the other hand, can be of particular advantage, for example, to the effect that the latching fastening can allow at least a certain rotation of the insert. Unlike in the case of a screw lock, for example, a rotation is possible or does not lead to a release of the insert, which, in combination with the elastomer joint, permits a very flexible line guidance. There is an additional degree of freedom to a certain extent, which can be of advantage in particular in the case of an insert with a plurality of elastomer sleeves (if the lines run through the insert from different directions, for example, the introduction of force can be reduced by corresponding rotation). In summary, the combination of rotation plus tilting can therefore be of advantage with respect to the flexible line laying and also for reducing the introduction of force into the insert. Preferably, the latching fastening is provided in such a way that the insert is held in a latched manner in the casing tube independently of the rotational position, that is to say there is a snap seat in each rotational position (and the insert can also be brought into each rotational position, that is to say can be rotated completely circumferentially).

An introduction of force can result, for example, in the laying of one or more medium-voltage cables by the insert, because such cables can be comparatively thick and rigid. In general, an introduction of force which is applied via the line can be at least reduced by the elastomer joint (compared with a rigid arrangement), which can be of advantage conversely with respect to the latching fastening. Even in the case of thick and/or rigid lines, excessive transverse forces can be avoided with the tilting, that is to say an unintentional cancelling of the snap seat can be prevented. Irrespective of these details, the present subject matter can also be used in particular in a transformer station, for example a compact station which cannot be walked through or can only be walked through partially.

The elastomer joint can be provided, for example, in the form of an axial and/or radial elevation, in particular a wall of the insert can have a Z-shaped profile when viewed in an axial section. With the elevation or elevations, as in the case of a bellows, excess material is stored in order to permit a deflection/tilting.

In general, “made of concrete or stone” means that the wall or floor element is, for example, a concrete wall or slab or, for example, bricked from stones (bricks or concrete stones). According to a preferred embodiment, the casing tube is arranged in a wall element, specifically tilted below an upper edge of the floor structure on the outside and/or with respect to a horizontal direction. With respect to this tilting, the casing tube could generally also be integrated obliquely into a wall element which is straight per se, but the wall element preferably has an overhang in the region of the casing tube. In other words, an outer wall surface of the wall element in that region in which the casing tube is provided is partially horizontal and at the same time partially vertically downward. Accordingly, the insert is pushed into the casing tube obliquely from the bottom obliquely upward, which can be particularly critical with respect to accessibility, but is readily possible on account of the latching.

The variant “casing tube” can also be summarized in the form of the following aspects:
1. Use of an insert and a snap ring,
   in which the insert is mounted in a through-opening in a wall or floor element made of concrete or stone,
   wherein a line is laid through the insert and said insert is sealed against the line,
   wherein a casing tube which is installed in the wall or floor element forms the through-opening,
   and wherein, for mounting the insert, the snap ring is latched in the casing tube and thus holds the insert in position,
   for which purpose the snap ring engages behind a flank which is formed on an inner wall surface of the casing tube.
2. Use according to aspect 1, in which the snap ring which is latched in the casing tube presses a fastening portion of the insert, which fastening portion is provided from an elastomer material, against the inner wall surface of the casing tube.
3. Use according to aspect 1 or 2, in which the insert and the snap ring are in a plurality of parts in relation to one another, but are pushed into the casing tube together.
4. Use according to aspects 2 and 3, in which the fastening portion of the insert, which fastening portion is provided from the elastomer material, is pulled onto the snap ring and is seated axially in a form-fitting manner on the snap ring.
5. Use according to aspect 4, in which an engagement portion of the fastening portion engages behind a flank which is formed in an outer wall surface of the snap ring, wherein an outer wall surface of the engagement portion rises outwards opposite to a pushing-in direction, in which the snap ring and the insert are pushed into the casing tube.
6. Use according to aspect 4 or 5, in which an engagement portion of the fastening portion engages behind a flank which is formed in an outer wall surface of the snap ring, wherein a sealing portion of the fastening portion follows the engagement portion opposite to a pushing-in direction, in which the snap ring and the insert are pushed into the casing tube, and wherein the sealing portion forms an outwardly protruding elevation on its outer wall surface.
7. Use according to one of the preceding aspects, in which a threaded section which is formed on the inner wall surface of the casing tube forms the flank which is formed on the inner wall surface of the casing tube.
8. Use according to aspect 7, in which, prior to the mounting of the insert with the snap ring, when the casing tube is installed in the wall or floor element, a closure cover is held in the casing tube via the threaded section, which closure cover is subsequently removed for the mounting of the insert.
9. Use according to one of the preceding aspects, in which the snap ring which is latched in the casing tube is held in a latched manner independently of the rotational position, that is to say there is a snap seat in each rotational position.
10. Use according to one of the preceding aspects, in which the snap ring is provided from a hard plastic.
11. Use according to one of the preceding aspects, in which the snap ring has a pre-latching portion which is arranged upstream of the flank in a pushing-in direction, in which the snap ring and the insert are pushed into the casing tube.
12. Use according to one of the preceding aspects, in which the snap ring has a predetermined breaking point for opening up or separating off a part of the snap ring and consequently cancelling the snap seat.
13. Use according to aspect 12, wherein the predetermined breaking point, in relation to a longitudinal axis of the through-opening, extends at least partially axially along the snap ring, such that, when the predetermined breaking point is separated, a separating joint is created which allows a snap ring segment to be folded in towards the central axis of the casing tube.
14. Use according to one of the preceding aspects, in which the insert is provided at least partially from an elastomer material, wherein, in order to disassemble the snap ring, the elastomer material is separated and the snap ring is broken out.
15. Use according to one of the preceding aspects, in which the snap ring, when it takes its snap seat in the casing tube, latches audibly and this serves as a mounting control.
16. Use according to one of the preceding aspects, in which the casing tube is provided in a wall element with an overhang and the insert is inserted into the casing tube obliquely from the bottom obliquely upward.

The application furthermore relates to the use of an insert for mounting in a wall or floor element made of concrete or stone, wherein the insert has a joint (see below in detail). This variant, also referred to below as an “insert with joint”, can be combined in combination with the above-discussed variant “casing tube” (that is to say the snap ring) and/or the elastomer sleeve with supporting element and area structure, or can also be provided independently thereof.

As explained in detail below, a particularly advantageous application can lie in the field of the construction of compact stations, in particular of transformer compact stations. Although floor and/or walls are typically cast from concrete, they then have a reduced size in relation to conventional transformer stations; they cannot be walked through or can only be walked through partially, for example. A construction height of <2 m or even <1.5 m is then realized above the ground, which results overall in a space-saving and also inconspicuous appearance. This is intended to illustrate an advantageous field of application which is opened up with the present subject matter, but initially does not restrict the latter in its generality.

The present invention is based on the technical problem of specifying an advantageous use or a corresponding insert as the subject matter of the use.

This is achieved according to the invention with the use according to claim 1, wherein the corresponding insert has an elastomer sleeve for leading through and sealing against a line and a fastening portion for fastening in the through-opening. A peculiarity in this case lies in a joint which is formed between elastomer sleeve and fastening portion and permits a tilted positioning of the elastomer sleeve relative to the fastening portion and therefore relative to the through-opening. Consequently, when the line is laid through the elastomer sleeve and said line is sealed with respect to the line, said line does not have to pass through the insert in an axially parallel manner (not parallel to the through-opening longitudinal axis), but rather said line can also run through in a tilted manner. Therefore, for example with regard to radii of curvature etc., the extent within the through-opening itself can already be used for the desired line laying and alignment, which can generally help to optimize a space requirement and can open up in particular applications with restricted spatial conditions and therefore compact station construction mentioned at the outset.

Preferred embodiments can be found in the entire disclosure and in particular the dependent claims, wherein, in the description of the features, a distinction is not always made in detail between the different claim categories; in any case, the disclosure is always to be read implicitly both with respect to use aspects or method aspects and with respect to corresponding apparatus features.

In general, the line can also be, for example, a pipeline which is used either as a fluid line (for example district heating, also in station construction) or as a protective pipe for laying the actual line, in particular a cable. However, the line is preferably a cable, in particular an electrical cable, which is laid through the elastomer sleeve without further sheathing. In other words, the latter comes into direct contact with the outer wall surface of the cable, which can also be of advantage with respect to a space-saving arrangement.

In order also to be able to use the possibility of tilting, the line preferably has a significantly smaller diameter in relation to the through-opening. An outside diameter of the line can be, for example, at most ¾, ⅔, ½, ¼, or ⅕ of the diameter of the opening, that is to say of the clear width thereof. In the case of an opening and/or line with a non-circular cross section, within the scope of this disclosure, the “diameter” results as the mean value of smallest and greatest extent perpendicular to the respective axis, for example central axis of the line or longitudinal axis of the through-opening (of the line or through-opening), which corresponds to the circle diameter in the preferred case of the circular shape.

Generally, within the scope of this disclosure, “a” and “an” are to be read, without an explicitly opposite specification, as an indefinite article and therefore always also as “at least one” or “at least one”. It is therefore also possible, for example, for a plurality of lines to be laid through the through-opening and the insert, that is to say at least 2 or at least 3 lines, with possible (independent) upper limits at, for example, at most 6, 5, or 4 lines. The insert preferably has a plurality of elastomer sleeves (at least 2 or 3, for example not more than 6, 5, or 4), of which then not all necessarily have to be occupied in the application (it is also possible for only exactly one line to be led through an insert with a plurality of elastomer sleeves).

The elastomer sleeve, through which the line is laid, preferably has a cylindrical inner wall surface at least in one section. The inner wall surface which is smooth due to the cylindrical shape, that is to say straight when viewed in an axial section, can come into contact with the line in a correspondingly flat and therefore well-sealing manner. Said section can in this case extend axially over at least 1 cm, 2 cm, or 3 cm, with possible upper limits at, for example, at most 20 cm, 15 cm, or 10 cm. Generally, the specifications “axial”, “radial” and “circumferential” in this case relate, without an explicitly opposite specification, to the respective axis, that is to say, for example in the case of the elastomer sleeve, to the central axis thereof which, for example in the case of the cylindrical shape just described, coincides with the cylinder axis.

In general, the line can also be laid through in a parallel manner with respect to the longitudinal axis of the through-opening despite the tilting capability which is provided per se, namely the possibility of tilting which is provided per se is advantageous in principle. In a preferred embodiment, however, the line laying actually takes place in a tilted manner, namely the elastomer sleeve central axis is tilted by at least 15°, further and particularly preferably at least 25° and 35° in relation to the through-opening longitudinal axis. Upper limits which are independent of these lower limits can be, for example, at most 65°, 55°, or 45°. In general, the through-opening is preferably at least partially rotationally symmetrical, in particular rotationally symmetrical, about said longitudinal axis.

A preferred embodiment relates to the configuration of the insert or of the entire structure on the rear side, that is to say on a side which is axially opposite to the elastomer sleeve. In the application, the front side, toward which the elastomer sleeve protrudes, can typically face the ground, whereas said rear side faces the station interior or building interior. Irrespective of these details, in the present case, a region on the rear side of the insert (adjoining the elastomer sleeve in the opposite direction thereto) which, by definition, lies coaxially with the non-tilted elastomer sleeve and is dimensioned radially to at least 1.5 times its outside diameter is considered as a “rear-side space”.

In a preferred embodiment, said rear-side space is free, that is to say in other words no part of the insert and also no other part of the leadthrough arrangement is provided there, in particular no supporting element, sleeve element or supporting element for the line. In the completely mounted state, therefore, only the line runs in the rear-side space, it is empty proceeding from the line or lines, and its “free” configuration can permit a particularly flexible line laying in other words. In the axial direction, in relation to the elastomer sleeve central axis, the rear-side space can extend, for example, away from the elastomer sleeve over at least the fastening portion, particularly preferably it extends over the entire axial length of the through-opening. In addition to the specifications in the preceding paragraph, further lower limits of the radial extent can be, for example, at least 2.5 or 3.5 times the outside diameter of the elastomer sleeve, possible upper limits being, for example, at most 15 or 10 times.

In general, the articulated mounting between elastomer sleeve and fastening portion can also be realized, for example, via joint surfaces which slide against one another, for instance in the form of a ball joint or knee joint. In a preferred embodiment, however, the joint is an elastomer joint which is formed monolithically with the elastomer sleeve from the same elastomer material. “Monolithically” generally means continuously from the same material without interruption within the scope of this disclosure, that is to say without a material boundary therebetween.

The “elastomer material” is quite generally a plastic with elastic behavior. The Shore hardness (Shore A) thereof can be, for example, at most 90 Shore, 80 Shore, 75 Shore, or 70 Shore and (independently thereof), for example, at least 20 Shore, 25 Shore, 30 Shore, 35 Shore, or 40 Shore. It can be, for example, a rubber material, preferably a synthetic rubber, for instance EPDM (ethylene-propylene-diene, M group). Likewise, however, it can also be, for example, a thermoplastic elastomer (TPE) or a silicone-based material, for instance silicone rubber or silicone elastomer.

As discussed in detail below, the fastening portion is also preferably formed monolithically from the same elastomer material, that is to say the elastomer joint connects the elastomer fastening portion monolithically to the elastomer sleeve. In general, however, the elastomer joint and the fastening portion can also be provided, for example, in one piece with one another (not separable in a non-destructive manner), but nevertheless from different materials, for instance in the form of a multi-component injection-molded part. Therefore, for example, the elastomer joint and the elastomer sleeve can be injection-molded as a soft component, for instance from TPE, onto the fastening portion as a hard component, for instance from ABS. Irrespective of the embodiment in detail, the elastomer joint can be advantageous, for example, to the effect that it can create a seal in addition to the tiltability without a separate sealing element or additionally introduced sealing material (sealing foam or the like).

In general, the insert and the line are preferably mounted and sealed purely mechanically, that is to say, for example, no initially flowable and then expanding filling material (no PU foam or the like) is introduced into the through-opening for mounting. An advantage of the elastomer joint can lie, for instance in comparison with multi-part joints etc., in the comparatively simple and therefore also cost-optimized production in mass production. On account of the elastomer material, the elastomer joint can be compressed on a radial side during or for tilting and can be expanded on the radially opposite side (the elastomer sleeve central axis is tilted towards the compressed side and is tilted away from the expanded side).

According to a preferred embodiment, the elastomer joint has a funnel-shaped section which has a diameter which decreases in the axial direction toward the elastomer sleeve, wherein “diameter” in this context relates to a mean value of inside diameter and outside diameter. The funnel-shaped section therefore has an end on the fastening-section side with a larger diameter and an end on the elastomer sleeve side with a smaller diameter in relation thereto, wherein the diameter therebetween preferably decreases linearly. Overall, the diameter between the two ends of the funnel-shaped section can decrease, for example, by at least 10% or 15%, wherein possible upper limits (independently thereof) can be, for example, at most 40% or 30%. Axially, the funnel-shaped section can extend, for example, over at least 20% or 30% of the axial length of the elastomer sleeve, with possible upper limits at, for example, at most 150%, 100%, or 80%. Irrespective of these details, the conical inner wall surface of the funnel-shaped section at its end on the elastomer sleeve side preferably merges directly into the cylindrical (smooth, see front) inner wall surface of the elastomer sleeve.

In a preferred embodiment, the elastomer joint is formed with an elevation which protrudes axially when viewed in an axial section. Said elevation can protrude axially away from the fastening portion or toward the fastening portion, in particular an elevation can also protrude radially one after the other alternately toward the fastening portion and an elevation can protrude away from the fastening portion, that is to say the elastomer joint, that is to say a wall which forms the elastomer joint, can therefore have an S-shaped or Z-shaped profile when viewed in section. This is generally also possible in multiple repetitions, but it is also possible, for example, for exactly one elevation to protrude toward the fastening portion and away therefrom in each case. Irrespective of these details, the elevation(s) is/are preferably each closed circumferentially in itself, which can result, for example, in a largely symmetrical tiltability. A depression is preferably formed in a complementary manner with the elevation on the axially opposite side, which results in a good movability of the elastomer joint. In principle, excess material is kept available with the elevation or the corresponding “fold throw”, which excess material can be deflected correspondingly during tilting.

The “axial section” in this context relates to a sectional plane containing the elastomer sleeve central axis (in the case of a non-tilted elastomer sleeve), that is to say lies axially parallel. Alternatively to or also in combination with the axially protruding elevation, the elastomer joint can also be formed with one or more radially protruding elevations in a preferred embodiment. If, for example, a plurality of in each case radially protruding elevations are arranged axially one after the other, the joint can be made in a manner comparable to a straw. In general, the elastomer joint, when viewed in an axial section, has at least one elevation which protrudes axially and/or radially, wherein the elastomer joint wall is preferably formed with a complementary depression in a correspondingly axially and/or radially opposite manner. The elastomer joint preferably has both the funnel-shaped section (see front) and one or more elevations, wherein the funnel-shaped section is preferably arranged between the elastomer sleeve and the elevation(s).

According to a preferred embodiment, the fastening portion of the insert is formed monolithically with the elastomer joint and the elastomer sleeve from the same elastomer material, cf. the above definitions. In a preferred embodiment, the fastening portion is pressed radially outward against an inner wall surface delimiting the through-opening for mounting or in the mounted state. This can generally also take place, for example, by pressing by means of an expanding clamping ring, but the fastening portion is preferably mounted by means of a fastening element which is then held axially in a form-fitting manner in the through-opening, in particular with a snap ring.

In general, in a preferred embodiment, a casing tube which is installed in the wall or floor element forms the through-opening, the casing tube is preferably cast into a wall or floor element made of concrete (that is to say keeps the through-opening free in the solidified concrete). In general, “made of concrete or stone” means that the wall or floor element is, for example, a concrete wall or slab or bricked from stone (for example brick or concrete stone).

In a preferred embodiment, as stated, the fastening portion is fastened in the through-opening by producing an axial form fit, that is to say by a fastening element engaging behind a flank which is formed on the inner wall surface of the casing tube. Said fastening element is preferably formed on a projection which protrudes radially inward, particularly preferably a threaded section (see below in detail).

In a preferred embodiment, the fastening element is a snap ring which is latched in the casing tube and presses the fastening portion against the inner wall surface thereof. The combination of the elastomer sleeve, which can be tilted by means of the elastomer joint and serves for the seal with respect to the line, on the one hand, and the fastening by means of a latching/snap ring, on the other hand, can be of particular advantage, for example, to the effect that the latching fastening can allow at least a certain rotation of the insert. Unlike in the case of a screw lock, for example, a rotation is possible or does not lead to a release of the insert, which, in combination with the elastomer joint, permits a very flexible line guidance. There is an additional degree of freedom to a certain extent, which can be of advantage in particular in the case of an insert with a plurality of elastomer sleeves (if the lines run through the insert from different directions, for example, the introduction of force can be reduced by corresponding rotation). In summary, the combination of rotation plus tilting can therefore be of advantage with respect to the flexible line laying and also for reducing the introduction of force into the insert. Preferably, the latching fastening is provided in such a way that the insert is held in a latched manner in the casing tube independently of the rotational position, that is to say there is a snap seat in each rotational position (and the insert can also be brought into each rotational position, that is to say can be rotated completely circumferentially).

An introduction of force can result, for example, in the laying of one or more medium-voltage cables by the insert, because such cables can be comparatively thick and rigid. In general, an introduction of force which is applied via the line can be at least reduced by the elastomer joint (compared with a rigid arrangement), which can be of advantage conversely with respect to the latching fastening. Even in the case of thick and/or rigid lines, excessive transverse forces can be avoided with the tilting, that is to say an unintentional cancelling of the snap seat can be prevented.

During the assembly in the casing tube, the snap ring is pushed into the snap seat with an at least partially axial movement (this can also be combined, for example, with a slight rotation), preferably the axial component has the greatest proportion of the movement, particularly preferably the movement takes place exclusively axially. Despite a generally conceivable one-piece configuration of insert and snap ring (for instance as a two-component injection-molded part), the two are preferably in a plurality of parts in relation to one another, that is to say they can be disassembled in a non-destructive manner before the mounting in the casing tube. Nevertheless, they are preferably pushed into the casing tube together during the mounting, that is to say the insert is pushed in with the snap ring located therein.

In a preferred embodiment, a threaded section which is provided on the inner wall surface of the casing tube forms the flank which is engaged behind by the snap ring, cf. also the remarks at the outset (in contrast, in general, any desired projection on or a depression in the inner wall surface could also form the flank). The threaded section is preferably formed monolithically with the rest of the casing tube and/or extends circumferentially only over one segment, that is to say not completely circumferentially. There can then be a plurality of threaded sections which are distributed over the circumference and each extend over a segment. These threaded sections are preferably arranged at the same axial position and can preferably each extend over the same angle, in particular be at least partially rotationally symmetrical in relation to one another about the through-opening longitudinal axis.

Even if the casing tube is therefore designed with the threaded section for the insertion of a system cover, this option is not used in the present case, but rather the insert is fastened with the snap ring instead. This can expand the application possibilities, for example, the present subject matter can be used, for example, in an assembly environment which is difficult to access or is difficult to see, whereas a system cover can be screwed into a structurally identical casing tube under “normal” conditions. This creates flexibility, specifically the casing tube which is installed in the wall or floor element could only be removed/replaced with considerable effort, but the optional equipping with system cover or insert with snap ring nevertheless allows a later adaptation.

A preferred embodiment relates to the line being led through or the elastomer sleeve being sealed, which preferably takes place with the aid of a supporting element. Said supporting element is placed in the elastomer sleeve when the line is led through and holds said sleeve in an expanded state, with the result that the line can be led through easily. The supporting element, which preferably has the shape of a supporting sleeve, is subsequently removed axially, wherein the elastomer sleeve then comes into contact automatically with the outer wall surface of the line. For this purpose, in a state free of external forces, the elastomer sleeve preferably has an inside diameter which is smaller in relation to the outside diameter of the line.

This “passive” sealing of the elastomer sleeve by shrinking on can be of particular advantage in conjunction with the elastomer joint, because the elastomer joint can reduce an interaction between the elastomer sleeve and the insert. Therefore, the elastomer sleeve shrunk onto the line and therefore seated in a relatively “taut” manner on the line cannot lead to an undesired/excessive introduction of force into the fastening of the insert in the through-opening, on the one hand. On the other hand, an introduction of force into the elastomer sleeve itself can also be reduced, for example, with the tilting, that is to say a reliable seal can also be achieved, for example, without a tension clamp arranged on the elastomer sleeve. The advantages of the insert under spatially restricted/difficult-to-access conditions have already been discussed, wherein the elastomer sleeve which comes into contact automatically can constitute a further module. Under the restricted conditions, for example, no tensioning mechanism of a clamp then has to be actuated by rotation of a screw or the like, instead, after the line has been led through, the supporting element can simply be removed from the elastomer sleeve and the latter can therefore be sealed with respect to the line comparatively easily.

According to a preferred embodiment, if the supporting element is arranged in the elastomer sleeve and holds the latter in an expanded state, an area structure is arranged radially between the supporting element and the elastomer sleeve. If the supporting element is then removed from the elastomer sleeve, it slides along the area structure, which can simplify the removal. The supporting element can slide well on the area structure, which can be, for example, a fabric/nonwoven fabric layer or in particular a film or plastic film, because it has a lower friction (static and/or sliding friction) in relation to the area structure than it would have in comparison with the elastomer sleeve.

The supporting element is preferably a supporting sleeve, and the area structure itself is particularly preferably used to pull out the supporting sleeve. For this purpose, a section of the area structure which adjoins the section arranged radially between the supporting sleeve and the expanded elastomer sleeve can be folded inwards into the supporting sleeve around a first axial end of the latter. The section can in particular be so long that it protrudes or can at least be gripped at the opposite second axial end. For the purpose of removing the supporting sleeve, this section is then pulled in a pull-out direction which points from the first to the second axial end. This pull-out force is transmitted to the supporting sleeve at the first axial end via the wrap, with the result that it slides out of the elastomer sleeve in the pull-out direction (along the respective section of the area structure which still remains between the supporting sleeve and the elastomer sleeve).

In general, the elastomer sleeve is not pressed against the line with a separate clamping means in a preferred embodiment, that is to say, in the completely mounted state, for example no clamping ring or no tension clamp is arranged on an outer wall surface of the elastomer sleeve facing away from the line. In other words, the elastomer sleeve comes into contact with the line solely as a result of the automatic change in shape, preferably as a result of the removal of the supporting element. This mounting without a clamping ring and in particular without tools can be advantageous specifically with regard to restricted spatial conditions, because a tool then does not have to be handled additionally in the case of space which is limited in any case.

According to a preferred embodiment, a bead which rises radially outwards is provided on the outer wall surface of the elastomer sleeve, said bead preferably being closed circumferentially in itself. Particularly preferably, a plurality of beads can be provided axially one after the other and in each case closed in themselves. The bead/beads which is/are provided as part of the elastomer sleeve from the same elastomer material can be of advantage, for example, with respect to the mounting without a clamping ring or without tools, namely increase an intrinsic pressing-on force of the elastomer sleeve.

According to a preferred embodiment, the casing tube is arranged in a wall element, specifically tilted below an upper edge of the floor structure on the outside and/or with respect to a horizontal direction. With respect to this tilting, the casing tube could generally also be integrated obliquely into a wall element which is straight per se, but the wall element preferably has an overhang in the region of the casing tube. In other words, an outer wall surface of the wall element in that region in which the casing tube is provided is partially horizontal and at the same time partially vertically downward. Accordingly, the insert is pushed into the casing tube obliquely from the bottom obliquely upward, which can be particularly critical with respect to accessibility.

The variant “insert with joint” can also be combined in the form of the following aspects:
1. Use of an insert,
   which insert has an elastomer sleeve with a passage opening for a line to be led through,
   a fastening portion for fastening the insert in a through-opening, and a joint via which the elastomer sleeve is arranged in a tiltable manner on the fastening portion,
in which use
   the insert is mounted in a through-opening of a wall or floor element made of concrete or stone, and
   a line is laid through the elastomer sleeve and the elastomer sleeve is sealed with respect to the line.
2. Use according to aspect 1, in which, after the line is laid through the elastomer sleeve and the elastomer sleeve is sealed with respect to the line, a central axis of the elastomer sleeve is tilted by at least 15° with respect to a longitudinal axis of the through-opening.
3. Use according to one of the preceding aspects, in which, respectively in relation to a central axis of the elastomer sleeve, a rear-side space of the insert, which is axially opposite the elastomer sleeve and lies coaxially with the elastomer sleeve and is dimensioned radially to at least 1.5 times its outside diameter, is free, that is to say the laid line can be positioned there as desired.
4. Use according to one of the preceding aspects, in which the joint is an elastomer joint which is formed monolithically with the elastomer sleeve from the same elastomer material.
5. Use according to aspect 4, in which the elastomer joint has a funnel-shaped section with a diameter which decreases from the fastening portion toward the elastomer sleeve.
6. Use according to aspect 4 or 5, in which the elastomer joint, respectively in relation to a central axis of the elastomer sleeve, is formed with an axially protruding elevation when viewed in an axial section.
7. Use according to one of aspects 4 to 6, in which the elastomer joint, respectively in relation to a central axis of the elastomer sleeve, is formed with a radially protruding elevation when viewed in an axial section.
8. Use according to one of aspects 4 to 7, in which the fastening portion is also provided from the same elastomer material and is formed monolithically with the elastomer joint and the elastomer sleeve.
9. Use according to one of the preceding aspects, in which the fastening portion is fastened in the wall or floor element by pressing radially outward against an inner wall surface delimiting the through-opening.
10. Use according to one of the preceding aspects, in which a casing tube which is installed in the wall or floor element forms the through-opening and the fastening portion is fastened in the through-opening by producing a form fit.
11. Use according to aspects 9 and 10, in which the fastening portion is mounted in the through-opening with a snap ring which is latched in the casing tube and presses the fastening portion against the inner wall surface thereof.
12. Use according to one of the preceding aspects, in which a supporting element is arranged in the elastomer sleeve and holds the elastomer sleeve in an expanded state when the line is led through, wherein the supporting element is removed from the elastomer sleeve after the line has been led through, with the result that the elastomer sleeve comes into contact automatically with an outer wall surface of the line.
13. Use according to aspect 12, in which, when the supporting element holds the elastomer sleeve in the expanded state when the line is led through, an area structure is arranged radially between the supporting element and the elastomer sleeve, along which area structure the supporting element slides out of the elastomer sleeve after the line has been led through.
14. Use according to aspect 12 or 13, in which the elastomer sleeve is not pressed on with a separate clamping means.
15. Use according to one of the preceding aspects, in which, respectively in relation to a central axis of the elastomer sleeve, a circumferential bead which rises radially outwards is provided on an outer wall surface of the elastomer sleeve, preferably a plurality of beads which are respectively closed circumferentially in themselves and are axially spaced apart from one another are provided.

The invention is explained in more detail below on the basis of an exemplary embodiment, wherein the individual features can also be relevant for the invention in another combination within the scope of the independent claims and, furthermore, a distinction is not made in detail between the different claim categories.

### IN DETAIL

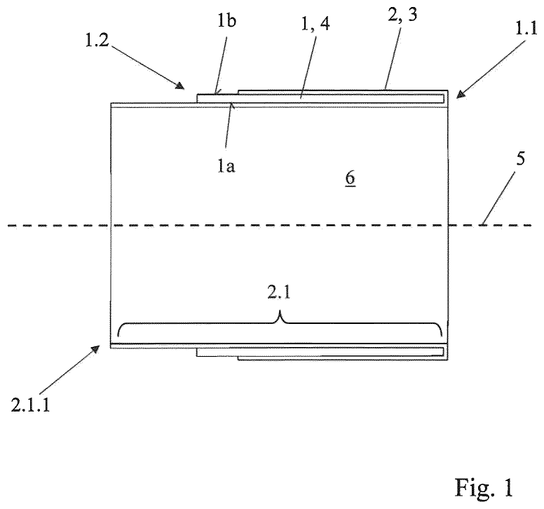

FIG. 1 shows a supporting sleeve with an area structure, specifically a plastic film wrapped around the supporting sleeve;

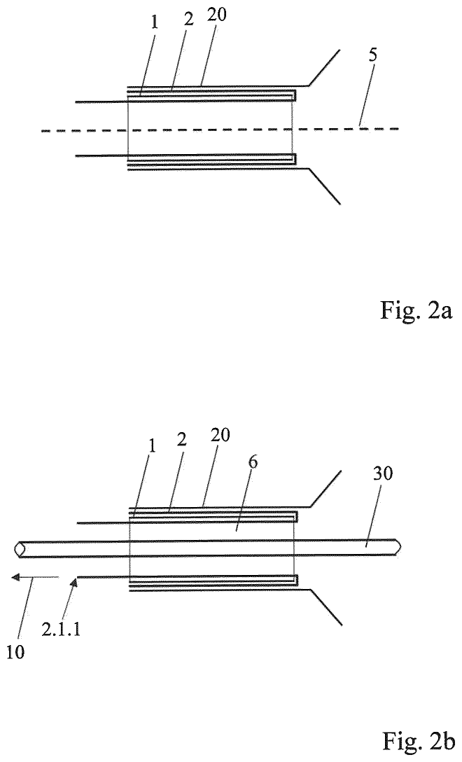

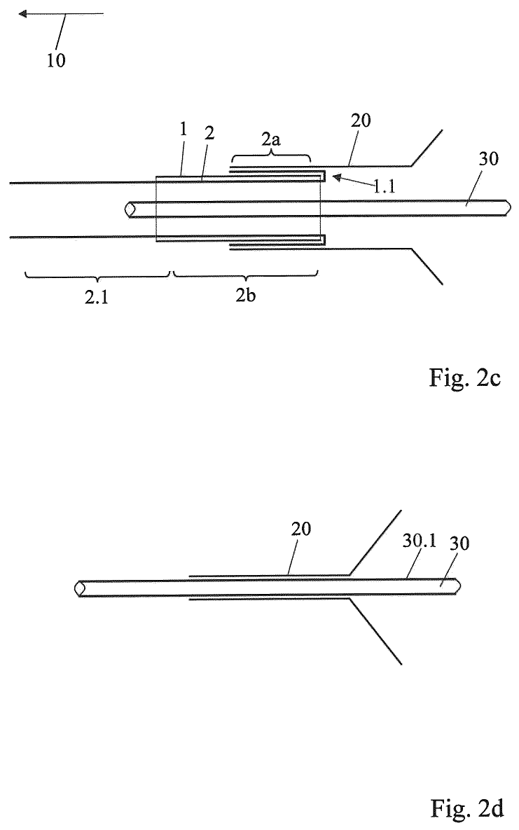

FIG. 2a shows in a schematic illustration, a supporting sleeve with an area structure which holds an elastomer sleeve in an expanded state;

FIG. 2b shows the arrangement according to FIG. 2a after a line has been led through;

FIG. 2c shows following the situation according to FIG. 2b, an intermediate state when the supporting sleeve is pulled out;

FIG. 2d shows the line with the elastomer sleeve which comes into contact with the line after the removal of the supporting sleeve;

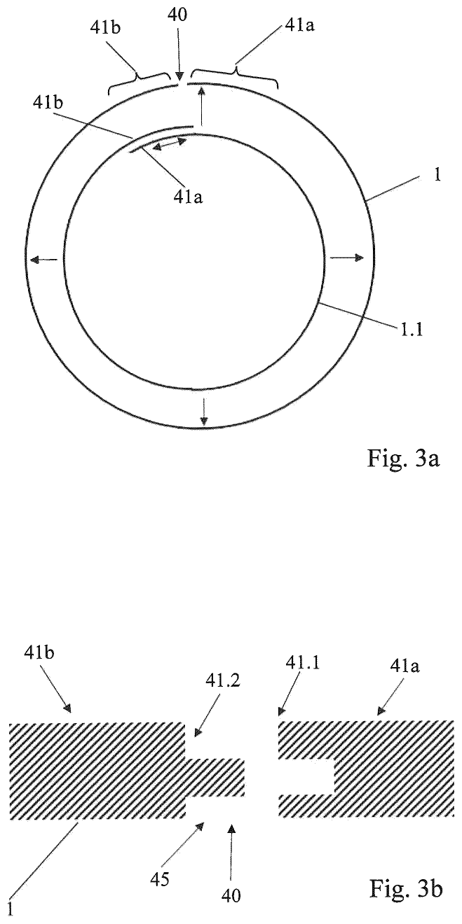

FIG. 3a shows an axially slotted supporting sleeve in a schematic axial view, namely in a compressed and expanded configuration;

FIG. 3b shows a detailed view with respect to FIG. 3a, namely a profiling of the edges at the axial slot;

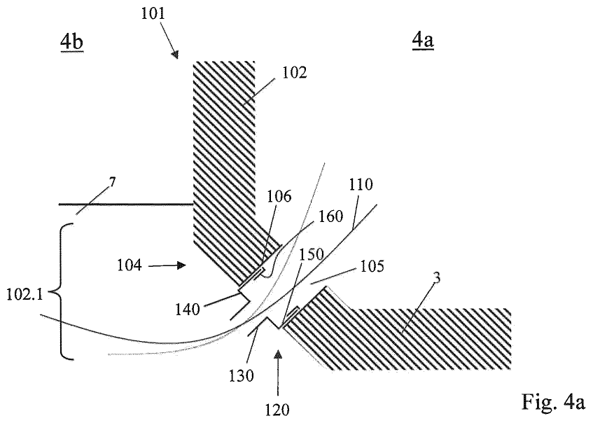

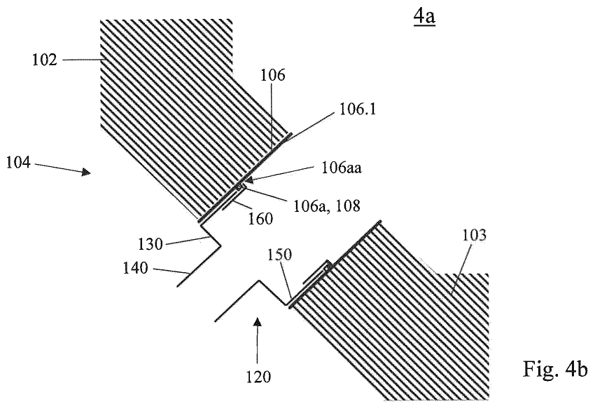

FIG. 4a shows in a schematic section, an insert which is mounted in a through-opening of a wall element, with exemplary line extensions;

FIG. 4b shows a detailed view with respect to FIG. 4a;

FIG. 5 shows the insert of an arrangement according to FIG. 4a in an oblique view;

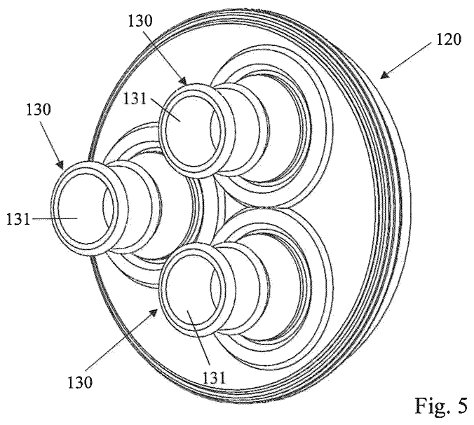

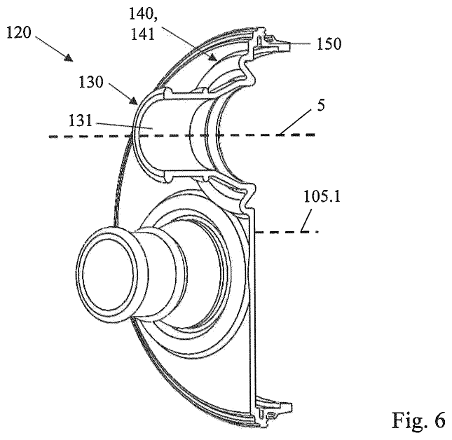

FIG. 6 shows the insert according to FIG. 5 in a sectional oblique view;

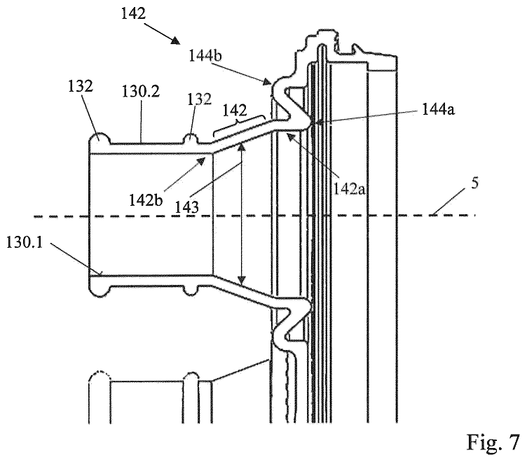

FIG. 7 shows an elastomer sleeve of the insert of FIGS. 5 and 6 in a sectional detailed view;

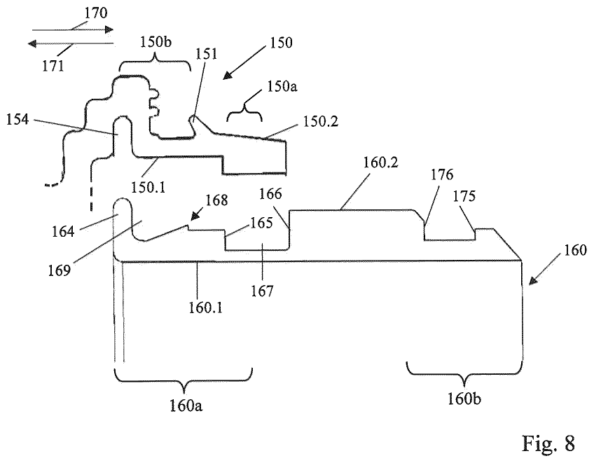

FIG. 8 shows a snap ring for mounting an insert according to FIGS. 5 and 3 in an arrangement according to FIG. 4a;

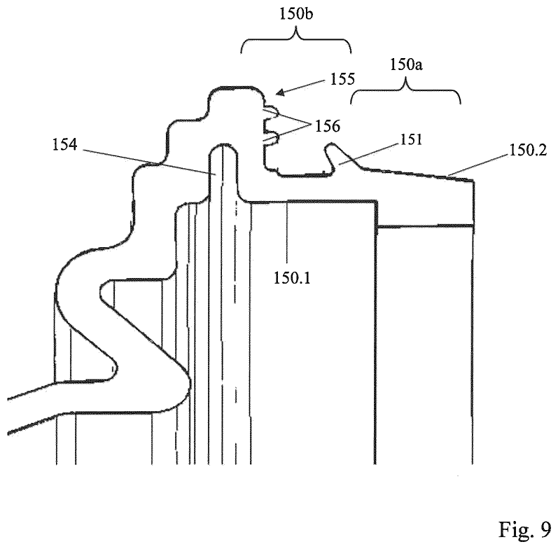

FIG. 9 shows a fastening poertion of the insert, which is mounted with the snap ring according to FIG. 8, in a sectional detailed view;

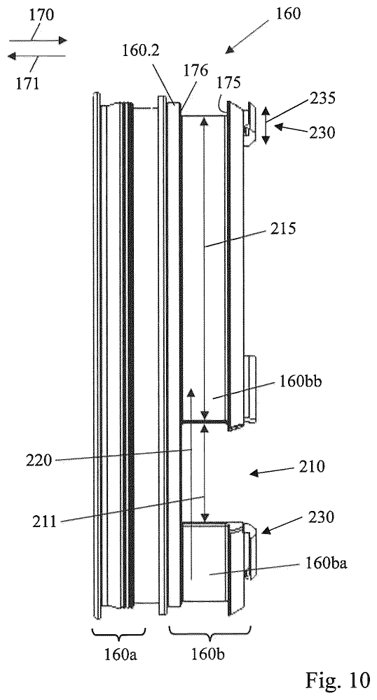

FIG. 10 shows a snap ring with some additional features in comparison with the variant according to FIG. 8;

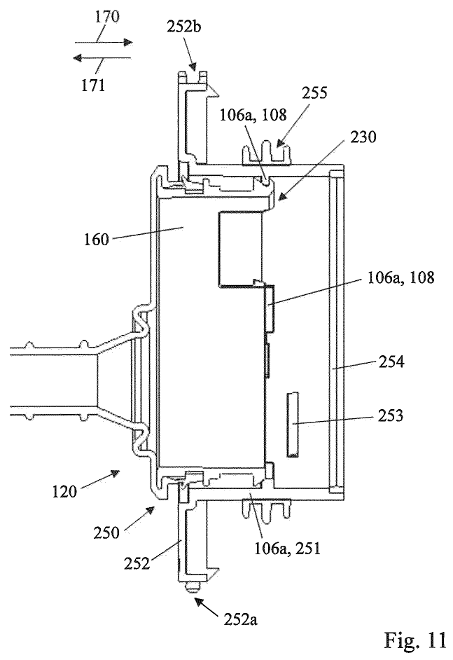

FIG. 11 shows an insert with the snap ring according to FIG. 10, namely in a casing tube of a feedthrough;

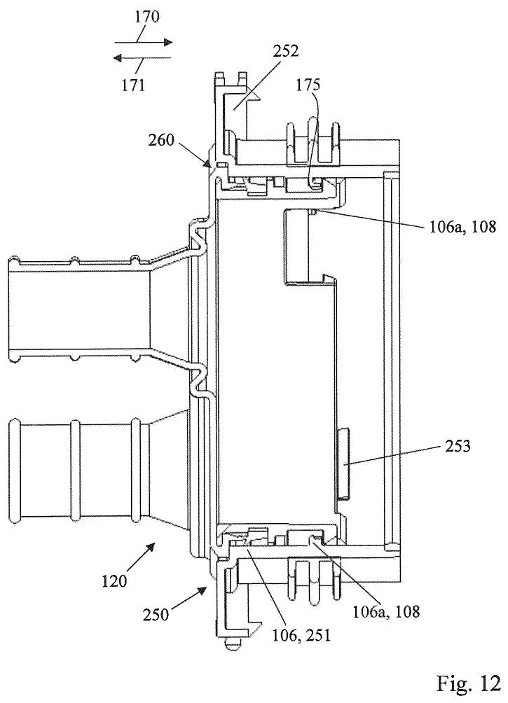

FIG. 12 shows the insert with snap ring according to FIG. 11, namely following the situation according to FIG. 11, i.e. in a completely latched state.

FIG. 1 shows, in a sectional side view, a supporting sleeve 1, around which an area structure 2 has been wrapped, in the present example a plastic film 3. This arrangement is placed, as explained in detail below, in an elastomer sleeve (not shown here), the central axis 5 of which lies in the sectional plane according to FIG. 1. The area structure 2 covers an outer wall surface 1b of the supporting sleeve 1 (in the present case not completely, but this is only an example) and is folded into the supporting sleeve 1 around a first axial end 1.1 of the latter, that is to say extends into a passage opening 6 which is delimited radially by the supporting sleeve 1.

The end section 2.1 of the area structure 2 which is folded in around the first end 1.1 extends along the inner wall surface 1a of the supporting sleeve 1 and protrudes out of the latter at the second axially opposite end 1.2 of the supporting sleeve 1. An end 2.1.1 of the area structure 2 is therefore in turn arranged outside the supporting sleeve 1. In the present example, the supporting sleeve 1 is a plastic tube made of polypropylene, and the area structure is a plastic film made of polyethylene. The latter has approximately a thickness of 50 μm. The axial length of the supporting sleeve 1 is approximately 5 cm.

FIG. 2a shows the supporting sleeve 1 and the area structure 2 in a starting situation corresponding to FIG. 1, wherein an elastomer sleeve 20 is additionally shown. The latter is held in a radially expanded state by the supporting sleeve 1, and therefore has a smaller diameter than the supporting sleeve 1. For differentiation, the area structure 2 is shown with a somewhat greater line thickness, but the actual thickness ratios correspond rather to FIG. 1, wherein the elastomer sleeve 20 can be made even somewhat thicker in relation to the supporting sleeve 1.

FIG. 2b shows the arrangement according to FIG. 2a after a line 30 has been led through. For the sake of clarity, the line 30 is shown in this schematic illustration with an outside diameter which is significantly smaller in relation thereto, but a line 30 can nevertheless be laid well through the passage opening 6 which is kept free of the supporting sleeve 1, even in practice.

As mentioned above, the supporting sleeve 1 holds the elastomer sleeve 20 in an expanded state, wherein the inside diameter of the latter in a force-free state is not only smaller than the outside diameter of the supporting sleeve 1, but also smaller than that of the line 30. If the supporting sleeve 1 is removed from the elastomer sleeve 20, the latter comes into contact with the line 30. For the purpose of removing the supporting sleeve 1, the area structure 2 is used in this case; in the situation according to FIG. 2b, it can be gripped at the end 2.1.1 which protrudes from the supporting sleeve 1 and pulled in a first axial direction 10.

FIG. 2c shows a situation in which approximately half of the supporting sleeve 1 has already slid out of the elastomer sleeve 20 (the contraction of the latter which takes place as a result is not shown in this schematic illustration). The supporting sleeve 1 can slide out of the elastomer sleeve 20 well along the area structure 2; the friction is therefore smaller than in the case of direct contact against the elastomer sleeve 20. In addition, the area structure 2 itself is used for pulling out; the tensile force which is applied to the end section 2.1 in the first axial direction 10 is transmitted there to the supporting sleeve 1 on account of the wrap at the first axial end 1.1. In summary, the supporting sleeve 1 can slide well along a section 2a of the area structure 2 which still remains between the supporting sleeve 1 and the elastomer sleeve 20, and the tensile force is transmitted to the supporting sleeve 1 via a section 2b which has already become free and via the end section 2.1.

FIG. 2d shows a situation after the complete removal of the supporting sleeve 1 with the area structure 2. Since it is now no longer held in an expanded state, the elastomer sleeve 20 contacts the line 30 due to its undersize, that is to say, lies flat against the outer wall surface 30.1 of the latter. Although this has been described in the present case with the supporting sleeve 1, the basic idea of the simplified sliding out can also be realized with a different supporting element (referenced generically with the reference sign 4 in FIG. 1).

FIG. 3a shows a schematic axial view of a supporting sleeve 1 in two different con-figurations and in this case illustrates a possible production step. The supporting sleeve 1 is provided with an axial slot 40 which passes through it radially over its entire axial length. On account of the slot 40, the supporting sleeve 1 can be brought into a radially compressed configuration 1.1 in which the end sections 41a, 41b lying at the slot 40 in the expanded configuration overlap.

As to the production, the elastomer sleeve 1 can be produced in particular in the radially compressed configuration, that is to say can be injection-molded or extruded, for example. In the radially compressed configuration 1.1, its outside diameter is equal to or (somewhat) smaller than the inside diameter of the elastomer sleeve 20, with the result that the radially compressed supporting sleeve 1 and the area structure can be easily inserted into the elastomer sleeve 20. In order to expand the elastomer sleeve 20, the supporting sleeve 1 is then expanded, that is to say an expansion tool is inserted into the supporting sleeve and the supporting sleeve is thus expanded. In this case, the end sections 41a, 41b slide against one another until the radially expanded configuration is reached and they bear against one another at the slot 40, that is to say are supported mutually in the circumferential direction. The expansion tool can then be removed, and the supporting sleeve holds the elastomer sleeve in an expanded state, as described above.

FIG. 3b shows, in a schematic section perpendicular to the axial direction, a possible configuration of the end sections 41a, b in detail. The abutting edges 41.1, 41.2 of the end sections 41a, b are provided with a profiling 45, in the present example a complementary tongue/groove profile. The profiling 45 further stabilizes the end sections 41a, b in the expanded configuration, namely prevents slippage and thus radial offset.

FIG. 4a shows a detail of a transformer station 101, which can be designed in particular as a compact station. The transformer station 101 has a wall element 102 and a floor element 103, wherein the wall element 102 slopes obliquely toward the floor element 103 in a lower section 2.1 with an overhang 104. There, a through-opening 105 is formed, which is kept free of a cast-in casing tube 106 in the wall element 102 produced by concrete casting. A line 110, specifically an electrical cable, is laid into the inner side 101a of the transformer station 101 through the through-opening 105, and runs on the outside 101b in the ground 107. By way of example, a further line extension is indicated by dashed lines, which can be required, for example, depending on the requirements on the station inner side 101a and/or in the ground 107.

In the following text, reference is additionally also made to FIG. 4b. An insert 120 which has an elastomer sleeve 130 is mounted in the through-opening 105. Said elastomer sleeve is connected to a fastening portion 150 via a joint 140 which is provided here only generically with the reference sign 140 and is not illustrated in detail. The insert 120 is mounted in the casing tube 106 via the fastening portion 150, specifically in a form-fitting manner by means of a snap ring 160. For this purpose, said snap ring engages behind a projection 106a which is formed on the inner wall surface 106.1 of the casing tube 106 and which is a threaded section 108. In detail, the snap ring 160 engages behind a flank 106aa of the projection 106a, which faces the inner side 101a. The elastomer sleeve 130 is mounted on the fastening portion 150 in a tiltable manner via the joint 140, with the result that said elastomer sleeve can be sealed with respect to the line even in the case of a tilted line guidance, that is to say different line extensions can be realized with the insert 120 depending on requirements.

FIG. 5 shows the insert 120 in an oblique view from the front, looking at it from the station outer side 101b. In this example, the insert 120 has three elastomer sleeves 130 which each define a passage opening 131 for a line to be led through. The elastomer sleeves 130 are structurally identical to one another, for which reason the following sectional illustration according to FIG. 103 relates only to one of them for the sake of clarity.

The section according to FIG. 6 contains a central axis 5 of the elastomer sleeve 130 (and also a central axis 105.1 of the through-opening 105). The joint 140 is provided in the form of an elastomer joint 141 via which the elastomer sleeve 130 is monolithically connected to the fastening portion 150. The insert 120 is provided overall as a monolithic elastomer part, and can therefore be produced in a molding method by injection molding or, for example, pressing into a mold.

FIG. 7 shows the elastomer sleeve 130 and the elastomer joint 141 further in detail. The elastomer joint 141 firstly has a funnel-shaped section 142 in which the diameter 143 decreases from an end 142a facing the fastening portion 150 to an end 142b facing the elastomer sleeve 130. Furthermore, the elastomer joint 141 in the present example has two axially protruding elevations 144a, b which result in an S-shaped wall profile with good tiltability. The elastomer sleeve 130 itself has a cylindrical, that is to say straight and axially parallel inner wall surface 130.1 when viewed in an axial section. In the present example, three monolithically integrally formed beads 132 which increase the intrinsic pressing-on force of the elastomer sleeve 130 and promote particularly good bearing against the line are provided on the radially opposite outer wall surface 130.2.

FIG. 8 shows a detail of the snap ring 160 in a section containing the longitudinal axis of the through-opening, wherein the longitudinal axis lies below the detail shown. Furthermore, in order to illustrate the interaction with the insert 120, the fastening portion 150 thereof is also shown, but offset radially outwardly. In fact, the fastening portion 150 is seated on the outer wall surface 160.2 of the snap ring 160, to be precise in a mounting section 160a thereof. Said mounting section is arranged downstream of a snap section 160b in relation to a pushing-in direction 170 and correspondingly upstream thereof in relation to the opposite pull-out direction 171. In the snap section 160b, the snap ring 160 forms a flank 175 with which it bears against the projection 6a of the casing tube 106 in the mounted state and is consequently held in an axially form-fitting manner. Axially opposite the flank 175, a further flank 176 is formed in the outer wall surface 160.2, which further flank can also constitute a stop for the pushing of the snap ring 160 into the casing tube 106; a threaded section which forms the projection 106a of the casing tube 106 can lie axially between the two flanks 175, 176 of the snap ring 160 in the latched state.

In the mounting section 160a, a flank 165 is formed in the outer wall surface 160.2, against which flank an engagement portion 150a of the fastening portion 150 bears axially in a form-fitting manner. In general, with respect to the configuration of the fastening portion, reference is additionally also made to FIG. 9. The outer wall surface 150.2 of the fastening portion 150 is also made so as to rise opposite to the pushing-in direction 170 in the region of the engagement portion 150a, with the result that the engagement portion 150a is pressed into its seat in the groove 167 which is formed between the flanks 155, 166 during the pushing into the casing tube or the through-opening.

In the sealing portion 150b of the fastening portion 150, the outer wall surface 150.2 is formed with an elevation 151 which is provided in the present case as a sealing lip which rises obliquely outwards opposite to the pushing-in direction 170. Said sealing lip comes into contact with or is pressed against the inner wall surface of the casing tube during the pushing into the latter. A projection 168 which is provided in the outer wall surface 160.2 of the snap ring 160 can further promote said pressing. Arranged upstream of the projection 168 in the pushing-in direction 170, a depression 169 is formed in the outer wall surface 160.2, into which depression “excess” elastomer material can be deformed.

Furthermore, the snap ring 160 is provided axially at the end side with a flange 164 which likewise serves for holding in a form-fitting manner by corresponding engagement in a complementary depression 154 of the fastening portion 150 and can also press a flank 155 of the fastening portion 150, which flank faces the wall/floor element, against the side surface of the latter. The inner wall surface 160.1 of the snap ring 160, which inner wall surface is radially opposite to the outer wall surface 160.2, is cylindrical, that is to say is smooth in section. This can, for example, prevent entanglement when the line is being led through.

FIG. 10 shows a snap ring 160 in a side view, wherein the features which are the same in comparison with FIG. 8 or features with the same function are provided with the same reference signs, and in this respect reference is also made to the above description. In contrast to the variant according to FIG. 8, the spacing between the flanks 175, 176 is somewhat greater, that is to say conversely the outer wall surface 160.2 is shortened somewhat axially. The radial deflectability of the snap-in flank 175, for example, can be influenced via the axial length of the section which is arranged in front of the flank 176 in relation to the pushing-in direction 170, that is to say conversely the force which is necessary for pushing into the latched state can be set somewhat smaller, for example, in FIG. 10 than in FIG. 8 (because the radially thicker section is axially shorter in FIG. 10).

Furthermore, a separating joint 210 of the flank 175 can be seen in the side view according to FIG. 10. Said separating joint 210 extends axially a distance into the snap section 160b, that is to say subdivides the latter into snap tongues 160ba, bb in relation to the circumferential direction 220. In this case, the width 211, taken in the circumferential direction 220, of the separating joint 210 is dimensioned in such a way that the flank 175 always remains latched independently of the rotational position, which alternatively or additionally to a corresponding dimensioning of the separating joint 210 in the case of a plurality of circumferentially distributed separating joints (not visible in the side view according to FIG. 10) can also be set by the rotational positions or angular spacings thereof in relation to the rotational positions/an-gular spacings of the projections or threaded sections of the casing tube. The deflectability of the snap tongues 160ba, 160bb can be influenced via the width 211 of the separating joint 210 (the greater the lighter), that is to say the force expenditure which is necessary for the latching can be influenced.

The snap ring 160 according to FIG. 10 furthermore has pre-latching portions 230 which are arranged in front of the actual snap section 160b with the flank 175 in relation to the pushing-in direction 170, that is to say reach the projections or threaded sections of the casing tube first when the snap ring 160 is pushed in. In comparison with the width 215, taken in the circumferential direction 220, of the respective snap tongue 160ba, 160bb, the width 235, taken in the circumferential direction 220, of the respectively associated pre-latching portion 230 is significantly smaller. Accordingly, the snap ring 160 would not yet be held on the projections or threaded sections independently of the rotational position solely via the pre-latching portions 230. Although the pre-latching portions 230 can be latched on the projections at a specific rotational position, the snap ring 160 could then still be released by rotation.

On account of the relatively smaller width 235 of the pre-latching portions 230, the latter can be latched more easily on the projections or threaded sections, that is to say the force expenditure for reaching a pre-snap position is lower than for the completely latched state. Nevertheless, the pre-latching portions 230 can already create a certain hold in the pre-snap position, that is to say a fitter can check, for example, whether the positioning of the insert matches the desired line laying. The pre-latching portions 230 can also prevent, for example, oblique “tipping out” of the snap ring 160 with the inserted insert when the insert and thus the snap ring is pressed into the latching position by a fitter, in particular when the corresponding pressing-in force is applied successively circumferentially at different rotational positions.

FIG. 11 shows the snap ring 160 according to FIG. 10 in a pre-latched state, wherein one of the pre-latching portions 230 can be seen in the sectional side view. Said snap ring engages behind the projection 106a or threaded section 108, which, together with the other pre-latching portions (not visible here), creates the pre-snap just described.

Irrespective of this, FIG. 11 also illustrates further details of the casing tube 106, which in this example is a pipe element 251 of a feedthrough 250. Said feedthrough additionally has a flange plate 252 which is formed monolithically with the pipe element 251, that is to say from the same continuously continuous plastic material without interruption. The feedthrough 250 can be mounted on a formwork during the setting in concrete via the flange plate 252, furthermore, the flange plate 252 can be assembled modularly with the flange plates of further feedthroughs via form-fitting elements 252a, b. A further tube piece (not shown here), which can be pushed in from the right as far as a stop 253 in FIG. 11, can adjoin the pipe element 251 in the pushing-in direction 170. A seal 254 provided on the inside of the pipe element 151 seals with respect to the pushed-in tube piece, and a web seal 255 provided on the outside of the pipe element 151 is surrounded by the concrete after the casting.

FIG. 12 shows, following the situation according to FIG. 11, the completely latched state, in which therefore the flank 175 of the snap section 160b engages behind the projections 106a or threaded sections 108. As described above, the insert 120 is then pressed by the snap ring 160 sealingly against the casing tube 106 or the feed-through 250. In contrast to the variant according to FIGS. 8 and 9, the insert 120 according to FIGS. 11 and 12 is provided in the fastening portion 150 on the front side not with a plurality of steps but with a chamfer 260. Said chamfer drops radially outward, wherein the radially outer end lies flush with the flange plate 252 in the latched state. This can permit the fitter visual inspection of the correct mounting or latching position.

1. A method of using an elastomer sleeve for mounting on a line, the method comprising the steps of:
i) first, the line is laid through the elastomer sleeve and in the process a supporting element is arranged in the elastomer sleeve and holds the elastomer sleeve in an expanded state;
ii) subsequently, the supporting element is removed from the elastomer sleeve and the elastomer sleeve comes into contact with the line;
wherein in step i), in relation to a central axis of the elastomer sleeve, an area structure is arranged radially between the supporting element and the elastomer sleeve,
and wherein the supporting element in step ii) slides out of the elastomer sleeve along the area structure.

2. The method according to claim 1, in which the supporting element is a supporting sleeve which in step ii) slides out of the elastomer sleeve along the area structure .

3. The method according to claim 2, in which the supporting sleeve is pulled out of the elastomer sleeve by means of the area structure, namely the supporting sleeve slides out of the elastomer sleeve in a first axial direction, which points from a first to a second axial end of the supporting sleeve, along a section of the area structure still remaining between the supporting sleeve and the elastomer sleeve at a respective point in time, and the force necessary for this is applied to the second axial end of the supporting sleeve in that a section of the area structure which has already become free at the respective point in time is pulled out through the supporting sleeve in the first axial direction.

4. The method according to claim 3, in which already in step i) an end section of the area structure is folded inwards into the supporting sleeve around the first axial end of the supporting sleeve, wherein this folded-in end section is gripped after step i) and pulled in the first axial direction.

5. The method according to claim 4, wherein the folded-in end section of the area structure already protrudes in step i) from the second axial end of the supporting sleeve, namely an end of the end section is arranged outside the supporting sleeve.

6. The method according to claim 5, in which the end of the end section in step i) is arranged radially outside the elastomer sleeve, namely the end section is folded outwards around the second axial end of the supporting sleeve.

7. The method according to claim 2, in which the supporting sleeve after step ii) is removed radially from the line, namely the line is moved out through an axial slot in the supporting sleeve.

8. The method according to claim 1 in which the area structure is a plastic film.

9. The method according to claim 8, in which the plastic film is made of polyethylene.

10. The method according to claim 1, in which the area structure is closed circumferentially in itself, in relation to a central axis of the elastomer sleeve.

11. The method according to claim 1, in which the area structure has a tubular shape, namely has a hollow cylindrical shape after being removed from the elastomer sleeve.

12. An elastomer sleeve arrangement for a method of use according to claim 1, the elastomer sleeve arrangement comprising:
an elastomer sleeve for mounting on a line;
a supporting element which is arranged in the elastomer sleeve and holds the latter in an expanded state;
and an area structure which, in relation to a central axis of the elastomer sleeve, is arranged radially between the supporting element and the elastomer sleeve.

13. The elastomer sleeve arrangement according to claim 12, in which the supporting element is a supporting sleeve which has an axial slot.

14. The elastomer sleeve arrangement according to claim 13, in which abutting edges of the supporting sleeve which bear against one another at the slot are provided with a profiling.

15. A method for producing an elastomer sleeve arrangement according to claim 13, the method comprising the steps of:
which the supporting sleeve is introduced into the elastomer sleeve in a radially compressed configuration in which end sections of the supporting sleeve overlap; and
the supporting sleeve is subsequently radially expanded and thus the elastomer sleeve is expanded until abutting edges of the end sections bear against one another.

16. A method of using an insert, the insert having an elastomer sleeve with a passage opening for a line to be led through, a fastening portion for fastening the insert in a through-opening, and a joint via which the elastomer sleeve is arranged in a tiltable manner on the fastening portion, the method comprising the steps of:
the insert is mounted in a through-opening of a wall or floor element made of concrete or stone; and
a line is laid through the elastomer sleeve and the elastomer sleeve is sealed with respect to the line.

17. The method according to claim 16, in which the joint is an elastomer joint which is formed monolithically with the elastomer sleeve from the same elastomer material.

18. The method according to claim 17, in which the elastomer joint, respectively in relation to a central axis of the elastomer sleeve, is formed with an axially protruding elevation when viewed in an axial section.

19. A method of using an insert and a snap ring, the method comprising the steps of:
the insert is mounted in a through-opening in a wall or floor element made of concrete or stone;
a line is laid through the insert and said insert is sealed against the line;
a casing tube which is installed in the wall or floor element forms the through-opening; and
the snap ring is latched in the casing tube and thus holds the insert in position, such that the snap ring engages behind a flank which is formed on an inner wall surface of the casing tube.

20. The method according to claim 19, in which the snap ring which is latched in the casing tube presses a fastening portion of the insert, which fastening portion is provided from an elastomer material, against the inner wall surface of the casing tube.
